(19) United States
(12) Patent Application Publication
(10) Pub. No.: US 2026/0154042 A1
(43) Pub. Date: Jun. 4, 2026

(54) SYSTEM FOR, AND METHOD OF, PROVIDING AN ABSOLUTE ZERO-CODE APPLICATION COMPOSITION PLATFORM

(71) Applicant: UCBOS, Inc., Marietta, GA (US)

(72) Inventor: Shanmugavel Muthuvelu, Marietta, GA (US)

(21) Appl. No.: 19/405,375

(22) Filed: Dec. 1, 2025

Related U.S. Application Data
(60) Provisional application No. 63/726,454, filed on Nov. 29, 2024.

(51) Int. Cl. G06F 8/20

(52) U.S. Cl. CPC G06F 8/20

(57) ABSTRACT

A system for, and method of, providing an absolute zero-code application composition platform are provided. The platform enables users to design, configure, and deploy enterprise-grade applications entirely through configuration, without generating, packaging, or maintaining any software code. The system comprises an intelligent software shell, semantic metadata framework, unified logical data model, operational semantic database, business process engine, integration and orchestration services, user experience layer, and security and compliance features. The invention eliminates technical debt, enables unlimited solutioning, and supports real-time interoperability across disparate systems.

### CROSS-REFERENCE TO RELATED APPLICATIONS

This application claims the benefit of U.S. Provisional Application 63/726,454 filed on Nov. 29, 2024, the disclosure of which is incorporated herein by reference in its entirety.

### FIELD OF THE INVENTION

Described herein is an exemplary system for, and method of, providing an absolute zero-code application composition platform, which enables users to design, configure, and deploy enterprise-grade applications entirely through configuration, without generating, packaging, or maintaining any software code. The exemplary systems and methods comprise an intelligent software shell, semantic metadata framework, unified logical data model, operational semantic database, business process engine, integration and orchestration services, user experience layer, and security and compliance features. The exemplary systems and methods eliminate technical debt, enable unlimited solutioning, and support real-time interoperability across disparate systems.

### BACKGROUND OF THE INVENTION

Traditional software development, whether for cloud or on-premise applications, relies on rigid constructs defined by specific business requirements and boundary conditions. These systems require predefined data models, user interactions, and system outputs, resulting in inflexible solutions that force customers to adapt or incur significant technical debt for customizations. Existing approaches, despite their naming conventions to the contrary such as so-called Low-Code and No-Code platforms, still generate or package code, limiting true flexibility and perpetuating maintenance burdens.

### SUMMARY OF THE INVENTION

The present invention recognizes that there remains a need for a platform that enables enterprises to compose and continuously refine complex business applications without generating or maintaining any code, thereby reducing or eliminating technical debt and/or vendor dependencies.

The present invention recognizes that, whether it is cloud software or on-premise software, a software application commonly is approached from a construct where a specific scope called “Business Requirements” is defined with specific and rigid boundary conditions called “Assumptions.” The data input, data output, system interactions and user interactions commonly are predefined and designed in a very rigid manner and sold to external customers or to internal customers. Customers commonly are forced to adapt to these constructs. If they want to customize the construct to their fullest competitive advantage, either it is not available or it comes with very high technical debt and tedious development and deployment cycle.

In summary, with prior systems, an IT department commonly is stuck with the rigid data models and rigid code whether it is on-prem vendor packages, or cloud vendor subscriptions, or home-grown applications, or vendor/IT driven customizations.

The exemplary embodiments of the present invention improve over prior systems by allowing the enterprise to define and continuously refine their assumptions, user/system inputs, and expected system outputs. The exemplary embodiments of the present invention eliminate all the rigidities and allow business and technical architects to produce unlimited scenarios and solutions as outcomes with zero technical debt. In this way, the present invention provides increased speed (e.g., 10 times more speed) to market with zero throw away code and cost.

According to the exemplary embodiments of the present invention, applications can be independent (e.g., 100% independent) of the technology and hence the so-called “secret sauces” and customizations required can be accomplished with zero vendor dependencies and zero code. As a result, there is no more innovation ceiling for IT and Business, unlike with prior systems.

The present invention also recognizes that prior systems have not attempted to fully compose a complex solution without code. Rather, some in the field have previously tried only low code or pre-coded microservices which are meant for specific functionality on pre-defined data models. Prior systems have not made the technology work on any data model, and no known prior technology has been provided where you can start from scratch and compose Enterprise Resource Planning (ERP) like solutions with zero lines of code to start with and end with. In some instances, master data companies have tried using meta data driven solutions for three to four master data tables, but none have tried or provided complex end-to-end solutioning using 100% meta data.

In contrast to the prior systems, and as an improvement over those prior systems, the exemplary embodiments of the present invention provide Zero Code Technology, and more particularly, Absolute Zero Code Technology.

As explained with reference to the exemplary embodiments described herein, the present invention provides an “Absolute Zero-Code Application Composition Platform,” a system and method that enables users to design, configure, and deploy enterprise-grade applications without writing, generating, or maintaining any software code. The platform is implemented as an intelligent, empty software shell that contains no pre-existing data models, tables, business logic, integrations, or applications. Instead, it leverages a semantic metadata framework and unified logical data model to learn, compose, and orchestrate any type of business process, data integration, user interface, or artificial intelligence (AI) model through configuration alone.

Importantly, the platform improves upon prior systems and methods by enabling the composition, deployment, and maintenance of enterprise applications entirely through configuration, without generating, packaging, or maintaining any software code. The platform leverages a semantic metadata framework, unified logical data model, and operational semantic database to support unlimited solutioning, interoperability, and continuous refinement of business applications for any function or industry vertical.

For example, the exemplary embodiments leverage technologies, such as, but not limited to:

### Zero-Code Technology

No code is generated, packaged, or required for application composition or deployment.

### Operational Semantic Database

Enables dynamic learning and modeling of structured and unstructured data.

### Unified Logical Data Model

Supports real-time data integration and interoperability across disparate systems.

### Configurable Business Logic and Workflows

Business rules, process orchestrations, and user interfaces are composed via configuration, not code.

### Integration Platform as a Service (iPaaS) and Orchestration Platform as a Service (oPaaS)

Provides vendor-independent integration and orchestration capabilities.

### Scalability, Security, and Compliance

Supports enterprise requirements for performance, data governance, and regulatory compliance.

In some embodiments, a platform is provided that comprises an “Absolute Zero Code” technology platform, which is a software shell with no pre-existing data models, tables, business logic, integrations, or applications. Instead, the platform is designed to learn, compose, and orchestrate various types (e.g., any type) of business process, data integration, user interface, or AI/ML model entirely through configuration, without requiring code generation (e.g., without generating or maintaining any code).

The exemplary embodiments are not limited to any particular type of business process, data integration, user interface, or AI/ML model.

Exemplary features and technical aspects of the “Absolute Zero Code” technology platform include:

### Platform Architecture

In examples, the platform comprises a J2EE embedded server, front-end web framework (Angular, Node, NPM), SQL and NoSQL databases, integration engine (Apache Camel), MLAI engine (Apache Spark), messaging server (ActiveMQ), workflow engine (Flowable), and code analysis tools (SonarQube, Sonar Lint). This architecture supports robust, scalable, and secure enterprise application composition.

### Data Layer

In examples, the platform supports storage with indexing and transaction capabilities, multi-format data handling (XML, JSON, CSV, EDI, XLS, binary, text), semantic data (RDF, N-Triples), bitemporal support, and multi-tenancy via REST server. The platform enables dynamic unified logical data models and semantic metadata frameworks for real-time data integration and decisioning.

### Process Engine

In examples, custom process definition generation, event sequencing, gateways, parallel processing, BPMN 2.0 support, multitenancy, task management, scheduling, transaction auditing, and re-processing are all configurable without code. This engine allows orchestration of complex business processes and workflows.

### Integration Engine

In examples, an integration engine enables creation of custom contexts, components, routes, endpoints, processors, scheduled integration processing, routing, transformation, exception handling, auditing, logging, and staged event-driven architecture. Integration modules support connectivity with disparate platforms and protocols.

### Front End Framework

In examples, front end framework provides web-based configuration tools, responsive design, dynamic mobile forms, user-friendly modelers, and visualization widgets. Security is ensured via AWS Cognito, and document/report design is supported.

### MLAI Engine

In examples, an MLAI engine (machine learning artificial intelligence engine) supports configuration-based machine learning model training, forecasting, classification, regression, and pipeline management for AI/ML-driven business decisions.

### Collaboration and Connectivity

In examples, the platform interprets as-is data, creates cross-functional data, applies business rules across partners, maintains metadata, and supports partner-managed data interactions and approvals. Collaborative workflows are enabled for seamless business operations.

### User Experience

In examples, the platform features web-based configuration, responsive design, dynamic mobile forms, and a user-friendly modeler for both business and IT users.

### Business Process Engine Capabilities

In examples, business process engine capabilities provide strong BPMN and DMN support for business rule management, with flexibility and extensibility for enterprise-grade process modeling.

### Zero Code Technology Benefits

In examples, the platform delivers rapid integration, solutioning, business semantics, scenario building, asset processing, and solution augmentation. The platform provides extensive (e.g., unlimited) data modeler and solution customization, robust metadata repository, pattern recognition workflows, precomposed solutions, accelerators, and module/mobile designer services. These features may be achieved with zero technical debt, unlimited interoperability, and real-time data integrations.

### Scalability, Security, and Compliance

In examples, the platform supports horizontal and vertical scalability, high availability, reliability, performance, seamless user experience, enterprise-preferred identity management, SOC 1 and SOC 2 compliance, RBAC authorization, and AWS FDR certification.

### Monitoring and Analytics

In examples, the platform provides multi-layer transaction audit, dashboards, error monitoring, reprocessing, and real-time process monitoring for enterprise visibility and control.

### Flexibility and Adaptability

In examples, the platform provides zero code configuration, customizable metadata, translation, transformation, business workflows, and dashboard configuration at organization, business unit, and user role levels.

In this way, the exemplary platform according to the present invention enables the composition, deployment, and maintenance of enterprise applications entirely through configuration, without generating, packaging, or maintaining any software code. The platform leverages a semantic metadata framework, unified logical data model, and operational semantic database to support unlimited solutioning, interoperability, and continuous refinement of business applications for any function or industry vertical.

The exemplary embodiments of the present invention improve upon existing technology and overcome various problems with prior systems, such as, but not limited to:

### Vendor Dependance:

Disparate Systems; no interoperability;
Data in jail; dated data;
Inevitable Enterprise-Centric Customizations.

### Slow Innovation:

Cannot produce solutions at business speed;
Skilled technologist and data scientist;
Too many technologies; not cohesive.

### Increased IT Budget:

Costly legacy maintenance;
Modernization efforts are not prioritized.

The exemplary platform according to the present invention solves these and other problems by enabling the composition, deployment, and maintenance of enterprise applications entirely through configuration, without generating, packaging, or maintaining any software code. The platform leverages a semantic metadata framework, unified logical data model, and operational semantic database to support unlimited solutioning, interoperability, and continuous refinement of business applications for any function or industry vertical.

The exemplary platform provides innovation to On-Prem and Agility to Cloud applications by overcoming cross-functional barriers through Zero Code solutions, which are beneficial (e.g., critical) for current and future business. The exemplary platform provides innovation freedom by empowering enterprises to rapidly compose competitive edge solutions with data ownership for agile enterprise needs. The exemplary platform achieves faster solutions (e.g., 10× faster solutions) to market compared to prior technology and systems. The exemplary platform holds the DNA to compose enterprise real-time visibility, on-demand multidirectional orchestration, what-if scenario planning, and AI Prediction in an agile, composable approach. The exemplary platform achieves zero technical debt and does not generate a single line of code that is dependent on current or future enterprise data or connectors or functionality or API or ERP used by the customer. The exemplary platform reduces costs compared to prior technology and prior solutions.

For purposes of this disclosure, “Zero Code Technology” means a technology which allows the technologists to conceive an Enterprise Resource Planning (ERP) like idea and compose the entire journey including data modeling, data integration, process orchestrations, Application Programming Interface (API) orchestrations, user interfaces, mobile forms, artificial intelligence (AI) modeling, and end to end ERP like solutions purely as configurations in the platform where the platform does not generate any software code at all after you compose any number of data models or functionalities or full blown ERP like modules as various applications and solutions. The exemplary embodiments provide a true Zero Code technology invention where the technology is not dependent at all on any data model, business function or application and hence allowing unlimited solutioning keeping the technical debt at zero. In an exemplary embodiment, the platform does not even know or care what a user is designing and solutioning.

More particularly, an “absolute zero code” technology according to the exemplary embodiments is an empty software shell which is substantially free of data models, tables, data, business logic, integrations, and applications (e.g., has no data models, no tables, no data, no business logic, no integrations and no applications). However, the inventive technology has capability (e.g., is configured) to learn and compose various types (e.g., any type) of complex ERP like data models, understand any form of structured and unstructured data, compose unlimited business rules and logic, and compose unlimited user interfaces to interoperate between all data lakes, ERPs, packaged applications, legacy systems, spread sheets, people, machines and things and thus creating unlimited ERP like solutions and bespoke innovative solutions for all business functions and all industry verticals without requiring manual code generation (e.g., without creating a single new line of code).

Unlike prior solutions described herein, among other prior solutions, an exemplary embodiment of the present invention includes an Operational Semantic Database and a Unified Logical Data Model, seamlessly integrated into the package.

The present invention provides a so-called super intelligent “Empty shell” with zero data models, zero “industry or customer or vendor” specific pre-coded solution, integration, or User Interface components. The intelligent empty shell is capable of learning any data model and any data from any enterprise application and enterprise data ecosystems without boundaries. The intelligent empty shell also allows the IT and business users to compose any type of extendable dynamic data models, adaptable data integrations, re-composable user interfaces and highly complex business logic to produce ERP like complex solutions all through configurations from scratch. This exemplary technology is like a programming language. However, the intelligent empty shell according to the exemplary embodiments does not generate any new code behind the scenes, unlike prior low code platforms, and does not package the existing components into a new program, unlike prior NoCode platforms. Also, the exemplary embodiments do not require, or expect, the user to incorporate any new custom code in producing the outcomes either, and hence, the exemplary embodiments are truly a “Zero code” technology which produces unlimited possibilities of applications as outcomes which can be “Zero Code” bespoke applications for enterprise customers or “Zero Code” industry package applications for software development companies, such as SAP, Oracle, Blue Yonder, and others. For example, a software ERP vendor (e.g., “SAP”) can compose a new “Zero Code” Order Management Application, another software ERP vendor (e.g., Oracle) can compose a new “Zero Code” Transportation Management Application, and yet another software ERP vendor (e.g., Manhattan Associates, a world leading Warehouse Management Software vendor) can compose a new “Zero Code” Warehouse Management Application using the same technology and eliminate their current technical debt and achieve zero technical debt. The IT department of such enterprise companies can compose their own supply chain, or finance, or any other department or business function specific applications using the same technology and eliminate their technical debt as well. Even if 1000 customers buy this technology and create 100,000 applications, the empty shell does not add code (e.g., does not add a single line of code) for any of these customers or any of their applications. Hence, the customers do not have to maintain the old code, generate new code, troubleshoot the new code, compile the new code or deploy the new code anymore. According to the exemplary embodiments of the present invention, the platform does not maintain any customer or application specific code and thus proving that it is truly a disruptive invention.

The exemplary embodiments provide and/or improve business agility and robust IT.

In some examples, the present invention provides an innovative platform that combines Integration Platform as a Service (iPaaS) and Orchestration Platform as a Service (oPaaS) capabilities, thereby providing enhanced or unmatched flexibility and efficiency.

In some examples, the present invention provides integrations to talk to Oracle Cloud Fusion, Manhattan Cloud, SAP, etc., but which do not have any code that is dependent on the vendor, do not have any procurement related code, and do not have any supplier collaboration related code.

The exemplary embodiments of the present invention can be configured for composing various solutions. In an example, all those solutions can be composed on the same technology without a single solution specific code.

The exemplary embodiments of the present invention can be utilized by, for example, one or more of software development companies, IT departments, data platform companies, and/or System Integration Partners, among others.

The problems with prior solutions discussed herein, among other problems, are addressed by the present invention, a first exemplary embodiment of which comprises a system for zero-code application composition, comprising a semantic metadata framework configured to receive framework input comprising at least one of data definitions, external data, internal data, digital assets, user interface designs, API learnings, or sensor data, or a combination of two or more thereof, a processor configured to establish (e.g., create, develop, design, generate, build, or manage, etc.) a metadata framework (e.g., 360-degree metadata framework) based on the framework input, a processor configured to establish (e.g., create, develop, design, generate, build, or manage, etc.) one or more dynamic unified logical data models from the 360-degree metadata framework, a processor configured to learn, create, and/or house data with semantics embedded (e.g., semantic data), and a semantic composition framework configured to receive one or more learnings and outcomes from the metadata framework, unified logical data models, and semantic data, and to compose one or more application ingredients including at least one of business logic, user interface, integration, or artificial intelligence/machine learning components, or a combination of two or more thereof.

In another exemplary embodiment, a system for zero-code application composition, comprises a semantic metadata framework configured to receive framework input comprising at least one of data definitions, external data, internal data, digital assets, user interface designs, API learnings, or sensor data, or a combination of two or more thereof, one or more processors and non-transitory computer-readable storage mediums storing instructions comprising one or more algorithms that when executed by the one or more processors cause the one or more processors to perform steps to establish one or more 360-degree metadata frameworks based on the framework input, establish one or more dynamic unified logical data models from the one or more 360-degree metadata frameworks, and learn, create, and house data with semantics embedded, and a semantic composition framework configured to receive learnings and outcomes from the metadata framework, unified logical data models, and semantic data, and to compose application ingredients including at least one of business logic, user interface, integration, or artificial intelligence/machine learning components, or a combination of two or more thereof.

In another exemplary embodiment, the system enables bidirectional continuous learning and composition of zero-code applications for deployment across internal and external applications.

In another exemplary embodiment, the semantic metadata framework is further configured to handle both structured and unstructured data.

In another exemplary embodiment, the semantic composition framework is configured to compose business logic by aggregating learnings and outcomes from the metadata framework and unified logical data models.

In another exemplary embodiment, the semantic composition framework is configured to compose user interface elements based on learnings and outcomes from the metadata framework and unified logical data models.

In another exemplary embodiment, the semantic composition framework is configured to compose integration components for connecting with external systems and APIs.

In another exemplary embodiment, the semantic composition framework is configured to compose artificial intelligence and machine learning components for predictive and prescriptive analytics.

In another exemplary embodiment, the system supports unlimited application composition and deployment without generating, packaging, or maintaining software code.

In another exemplary embodiment, the system enables real-time interoperability and continuous refinement of business logic, user interface, integration, and AI/ML components.

Another exemplary embodiment is directed to a system for composing enterprise applications, comprising an intelligent software shell having no pre-existing data models, tables, business logic, integrations, or applications, a semantic metadata framework configured to define and manage application elements as metadata, a unified logical data model for real-time data integration and operational decision-making, an operational semantic database for ingesting, enriching, and governing structured and unstructured data, a business process engine for configuring business process flows, validations, and logic, integration and orchestration services for connecting to external systems without generating or maintaining code, and a user experience layer for configuring applications via web-based tools and mobile forms.

In another exemplary embodiment, the system further comprises one or more security and compliance engines for identity management and access control, wherein the system enables the composition, deployment, and maintenance of applications entirely through configuration, without generating, packaging, or maintaining any software code.

In another exemplary embodiment, the semantic metadata framework enables continuous refinement of application elements without code generation.

In another exemplary embodiment, the unified logical data model supports interoperability across disparate enterprise systems.

In another exemplary embodiment, the business process engine supports configuration of business logic and workflows using graphical tools.

In another exemplary embodiment, the integration and orchestration services provide vendor-independent connectivity and process automation.

Another exemplary embodiment is directed to a method for composing enterprise applications, comprising providing an intelligent software shell as described herein, receiving, by the semantic metadata framework, the application elements and defining the application elements as metadata, creating the unified logical data model based on the metadata, learning, creating, and housing the data with semantics embedded, and deploying and maintaining applications without generating or maintaining software code.

In another exemplary embodiment, the method further comprises configuring one or more data models, business logic, user interfaces, and integrations via graphical tools.

Another exemplary embodiment is directed to a method for zero-code application composition, comprising receiving, by a semantic metadata framework, framework input comprising at least one of data definitions, external data, internal data, digital assets, user interface designs, API learnings, and sensor data, establishing, by a processor, a 360-degree metadata framework based on the framework input, establishing, by a processor, dynamic unified logical data models from the metadata framework, learning, creating, and housing, by a processor, data with semantics embedded, and composing, by a semantic composition framework, application ingredients including business logic, user interface, integration, and artificial intelligence/machine learning components, based on learnings and outcomes from the metadata framework, unified logical data models, and semantic data.

In another exemplary embodiment, the method further comprises enabling bidirectional continuous learning and composition of zero-code applications for deployment across internal and external applications.

In another exemplary embodiment, the method further comprises handling both structured and unstructured data in the semantic metadata framework.

In another exemplary embodiment, the method further comprises composing business logic by aggregating learnings and outcomes from the metadata framework and unified logical data models.

In another exemplary embodiment, the method further comprises composing user interface elements based on learnings and outcomes from the metadata framework and unified logical data models.

In another exemplary embodiment, the method further comprises composing integration components for connecting with external systems and APIs.

In another exemplary embodiment, the method further comprises composing artificial intelligence and machine learning components for predictive and prescriptive analytics.

In another exemplary embodiment, the method further comprises supporting unlimited application composition and deployment without generating, packaging, or maintaining software code.

In another exemplary embodiment, the method further comprises enabling real-time interoperability and continuous refinement of business logic, user interface, integration, and AI/ML components.

Another exemplary embodiment is directed to a system for zero-code application composition, comprising means for receiving framework input comprising at least one of data definitions, external data, internal data, digital assets, user interface designs, API learnings, and sensor data, means for establishing a 360-degree metadata framework based on the framework input, means for establishing dynamic unified logical data models from the metadata framework, means for learning, creating, and housing, by a processor, data with semantics embedded, and means for composing application ingredients including business logic, user interface, integration, and artificial intelligence/machine learning components, based on learnings and outcomes from the metadata framework, the unified logical data models, and the semantic data.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 illustrates a comparison of prior systems with an Absolute Zero-Code Application Composition Platform and “Absolute zero code” technology according to an exemplary embodiment of the invention.

FIG. 2 illustrates exemplary aspects of an Absolute Zero-Code Application Composition Platform and “Absolute zero code” technology, according to an exemplary embodiment of the invention.

FIG. 3 illustrates exemplary capabilities of an Absolute Zero-Code Application Composition Platform and “Absolute zero code” technology, according to an exemplary embodiment of the invention delivering scalability, security and enterprise standard performance, among other things.

FIG. 4 illustrates exemplary integration capabilities of an Absolute Zero-Code Application Composition Platform and “Absolute zero code” technology, according to an exemplary embodiment of the invention.

FIG. 5 illustrates exemplary data management capabilities of an Absolute Zero-Code Application Composition Platform and “Absolute zero code” technology, according to an exemplary embodiment of the invention.

FIG. 6 is a diagram illustrating exemplary scalability and performance capabilities of components of an Absolute Zero-Code Application Composition Platform and “Absolute zero code” technology, according to an exemplary embodiment of the invention.

FIG. 7 is a diagram illustrating exemplary security and compliance capabilities of components of an Absolute Zero-Code Application Composition Platform and “Absolute zero code” technology, according to an exemplary embodiment of the invention.

FIG. 8 is a diagram illustrating exemplary monitoring and analytics capabilities of components of an Absolute Zero-Code Application Composition Platform and “Absolute zero code” technology, according to an exemplary embodiment of the invention.

FIG. 9 is a diagram illustrating exemplary flexibility and adaptability capabilities of components of an Absolute Zero-Code Application Composition Platform and “Absolute zero code” technology, according to an exemplary embodiment of the invention.

FIG. 10 is a diagram illustrating exemplary collaboration and connectivity capabilities of components of an Absolute Zero-Code Application Composition Platform and “Absolute zero code” technology, according to an exemplary embodiment of the invention.

FIG. 11 is a diagram illustrating exemplary user experience capabilities of components of an Absolute Zero-Code Application Composition Platform and “Absolute zero code” technology, according to an exemplary embodiment of the invention.

FIG. 12 is a diagram illustrating exemplary business process engine capabilities of components of an Absolute Zero-Code Application Composition Platform and “Absolute zero code” technology, according to an exemplary embodiment of the invention.

FIG. 13 is a diagram illustrating rapid enterprise solutions of an Absolute Zero-Code Application Composition Platform and “Absolute zero code” technology providing a rapid enterprise solution, according to an exemplary embodiment of the invention.

FIG. 14 is a diagram illustrating exemplary components and capabilities of an Absolute Zero-Code Application Composition Platform and “Absolute zero code” technology providing a rapid enterprise solution, according to an exemplary embodiment of the invention.

FIG. 15 is a diagram illustrating an exemplary Absolute Zero-Code Application Composition Platform, according to an exemplary embodiment of the invention.

FIG. 16 is a diagram illustrating features and components of an exemplary all-in-one platform for SaaS and PaaS, according to an exemplary embodiment of the invention.

FIG. 17 is another diagram illustrating features and components of an exemplary all-in-one platform for SaaS and PaaS, according to an exemplary embodiment of the invention.

FIG. 18 is a diagram illustrating exemplary components and capabilities of an Absolute Zero-Code Application Composition Platform, according to an exemplary embodiment of the invention.

FIG. 19 is a diagram illustrating case studies for enterprise centric solutions provided by an exemplary platform, according to an exemplary embodiment of the invention.

FIG. 20 is a diagram illustrating exemplary components of an Absolute Zero-Code Application Composition Platform, according to an exemplary embodiment of the invention.

FIG. 21 is a diagram illustrating exemplary components of overall architecture and core components of an Absolute Zero-Code Application Composition Platform, according to an exemplary embodiment of the invention.

FIG. 22 is a diagram illustrating an exemplary 360 degree semantic metadata framework, and learning and modeling flow, for an Absolute Zero-Code Application Composition Platform, according to an exemplary embodiment of the invention.

FIG. 23 is a diagram illustrating an exemplary semantic composition framework for an Absolute Zero-Code Application Composition Platform, according to an exemplary embodiment of the invention.

FIG. 24 is a diagram illustrating exemplary components and processes for composing absolute zero-code applications in an Absolute Zero-Code Applications Composition Platform according to an exemplary embodiment of the invention.

FIG. 25 is a diagram illustrating exemplary architecture of an Absolute Zero-Code Application Composition Platform, according to an exemplary embodiment of the invention.

FIG. 26 is a diagram illustrating example implementation of an Absolute Zero-Code Application Composition Platform, according to an exemplary embodiment of the invention.

FIG. 27 is a diagram illustrating exemplary architecture components of an Absolute Zero-Code Application Composition Platform, according to an exemplary embodiment of the invention.

FIG. 28 is a diagram illustrating exemplary data layer components of an Absolute Zero-Code Application Composition Platform, according to an exemplary embodiment of the invention.

FIG. 29 is a diagram illustrating exemplary process engine components of an Absolute Zero-Code Application Composition Platform, according to an exemplary embodiment of the invention.

FIG. 30 is a diagram illustrating exemplary integration engine components of an Absolute Zero-Code Application Composition Platform, according to an exemplary embodiment of the invention.

FIG. 31 is a diagram illustrating exemplary MLAI engine components of an Absolute Zero-Code Application Composition Platform, according to an exemplary embodiment of the invention.

FIG. 32 is a diagram illustrating exemplary front end framework components of an Absolute Zero-Code Application Composition Platform, according to an exemplary embodiment of the invention.

FIG. 33 is a diagram illustrating exemplary spring framework components of an Absolute Zero-Code Application Composition Platform, according to an exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

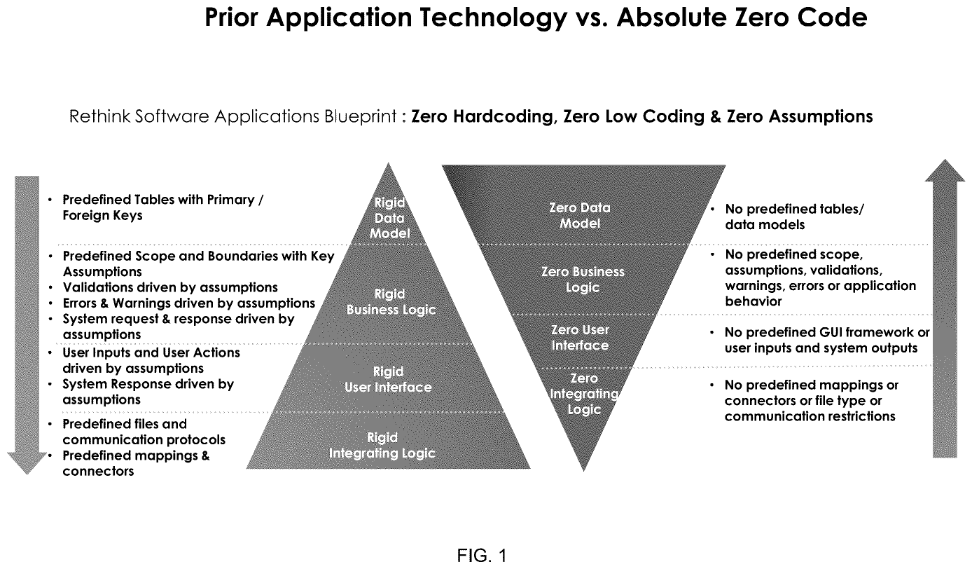

Referring now to the drawings, FIGS. 1-33 illustrate exemplary embodiments of the present invention. The exemplary embodiments are illustrated, for example, by diagrams showing the architecture of the zero-code platform, including the operational semantic database and unified logical data model, flowcharts depicting the configuration-driven composition of business applications, example user interfaces for configuring data models, business logic, and integrations, and system diagrams showing interoperability with external systems, data lakes, and legacy applications.

As described herein, “Absolute zero code” technology according to the present invention is an empty software shell which has no data models, no tables, no data, no business logic, no integrations and no applications. However, the inventive technology has the advanced smartness to learn and compose any type of complex ERP like data models, understand any form of structured and unstructured data, compose unlimited business rules and logic, and compose unlimited user interfaces to interoperate between multiple data lakes (e.g., all data lakes), ERPs, packaged applications, legacy systems, spread sheets, people, machines and things and thus creating unlimited ERP like solutions and bespoke innovative solutions for all business functions and all industry verticals without creating a single new line of code.

The exemplary embodiments rethink prior software application blueprints by enabling zero hardcoding, zero low coding, and zero assumptions. With reference to FIG. 1, prior systems require rigid data models, rigid business logic, rigid user interfaces, and rigid integrating logic. More particularly, prior systems require predefined tables with primary/foreign keys, predefined scope and boundaries with key assumptions, validations driven by assumptions, errors and warnings driven by assumptions, system request and response driven by assumptions, user inputs and user actions driven by assumptions, system response driven by assumptions, predefined files and communication protocols, and/or predefined mappings and connectors, among other things.

With reference again to FIG. 1, the present invention improves over prior systems by providing an Absolute Zero-Code Application Composition Platform and “Absolute zero code” technology enabling zero data models, zero business logic, zero user interfaces, and zero integrating logic. More particularly, the exemplary platform has no predefined tables/data models, no predefined scope, assumptions, validations, warnings, errors, and/or application behaviors, no predefined GUI framework or user inputs and system output, and no predefined mappings or connectors or file type or communication restrictions.

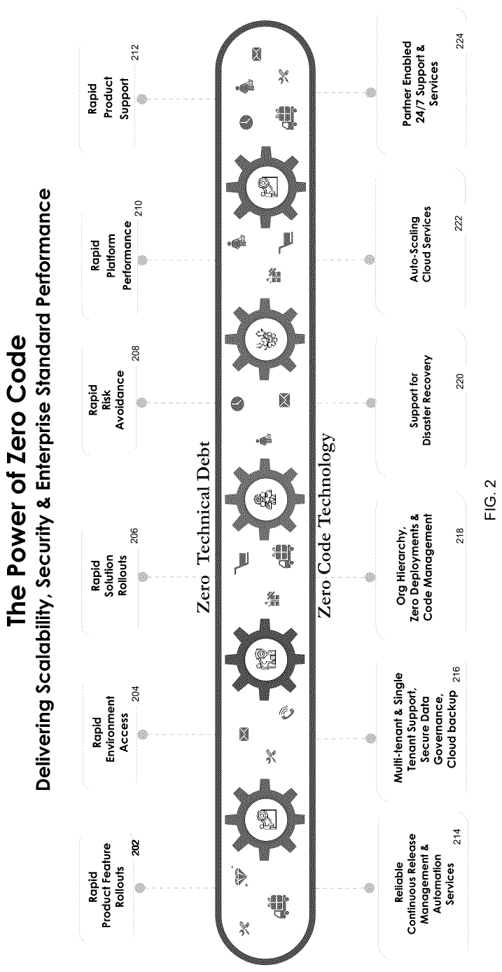

FIGS. 2-14 illustrate exemplary aspects of an Absolute Zero-Code Application Composition Platform and “Absolute zero code” technology, such as iPaaS, oPaaS, aPaaS, AIPaaS, delivering scalability, security and enterprise standard performance, among other things.

FIG. 2 is a diagram illustrating that the exemplary platform enables rapid product feature rollouts 202, rapid environment access 204, rapid solution rollouts 206, rapid risk avoidance 208, rapid platform performance 210, and/or rapid product support 212, reliable continuous release management and automation services 214, multi-tenant and single tenant support, secure data governance, cloud backup 216, org hierarchy, zero deployments and code management 218, support for disaster recovery 220, auto-scaling cloud services 222, and/or partner enabled support and services (e.g., 24/7 support) 224, among other things.

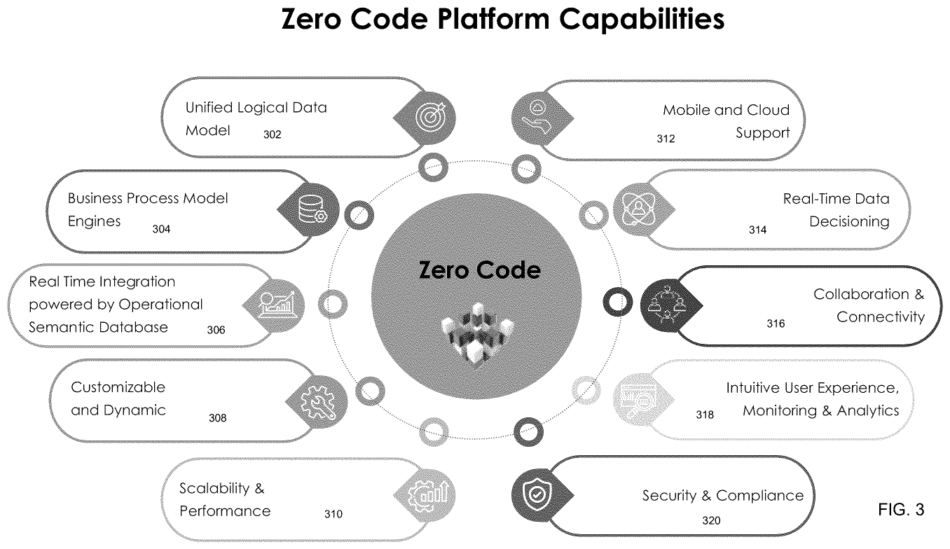

FIG. 3 is a diagram illustrating exemplary components and capabilities of an Absolute Zero-Code Application Composition Platform and “Absolute zero code” technology including, for example:
Unified Logical Data Model 302;
Business Process Model Engines 304;
Real Time Integration powered by Operational Semantic Database 306;
Customizable and Dynamic 308;
Scalability and Performance 310;
Mobile and Cloud Support 312;
Real-Time Data Decisioning 314;
Collaboration and Connectivity 316;
Intuitive User Experience, Monitoring and Analytics 318; and/or
Security and Compliance 320, among other things.

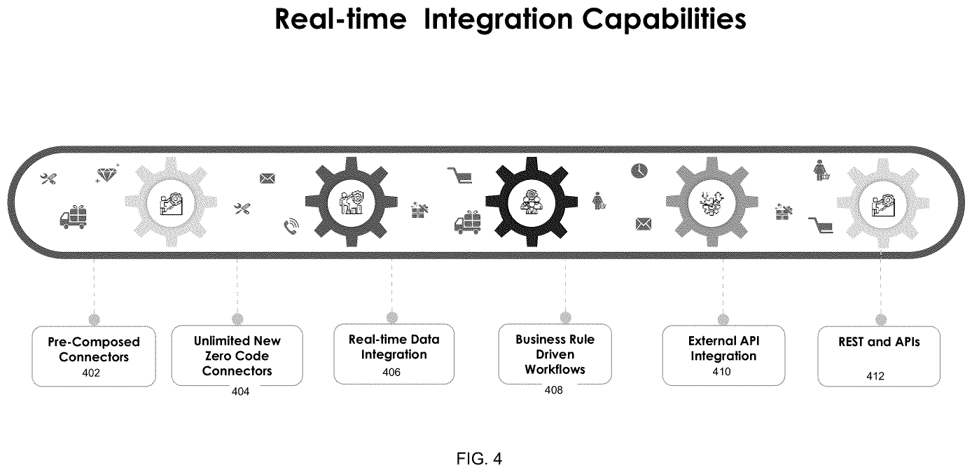

FIG. 4 is a diagram illustrating exemplary integration capabilities (e.g., real-time integration capabilities) of components of an Absolute Zero-Code Application Composition Platform and “Absolute zero code” technology, according to an exemplary embodiment of the invention, including:
Pre-Composed Connectors 402;
Unlimited New Zero Code Connectors 404;
Real-time Data Integration 406;
Business Rule Driven Workflows 408;
External API Integration 410; and/or
REST and APIs 412, among other things.

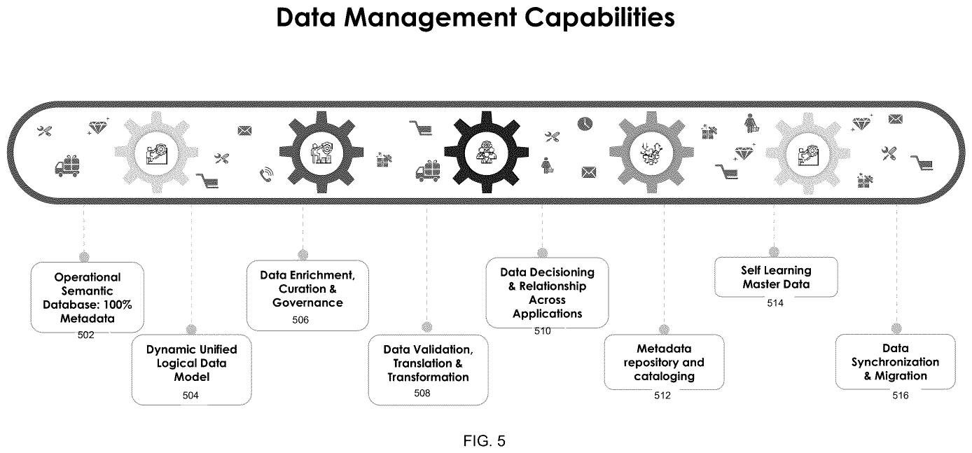

FIG. 5 is a diagram illustrating exemplary data management capabilities of components of an Absolute Zero-Code Application Composition Platform and “Absolute zero code” technology, including for example:
Operational Semantic Database 502:100% Metadata;
Dynamic Unified Logical Data Model 504;
Data Enrichment, Curation and Governance 506;
Data Validation, Translation and Transformation 508;-Data Decisioning and Relationship Across Applications 510;
Metadata repository and cataloging 512;
Self Learning Master Data 514; and/or
Data Synchronization and Migration 516, among other things.

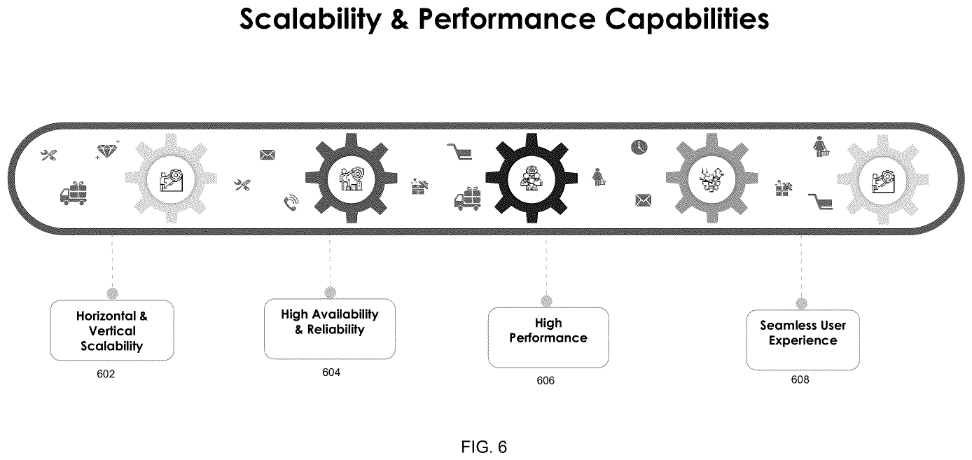

FIG. 6 is a diagram illustrating exemplary scalability and performance capabilities of components of an Absolute Zero-Code Application Composition Platform and “Absolute zero code” technology, including for example, horizontal and vertical scalability 602, high availability and reliability 604, high performance 606, and seamless user experience 608.

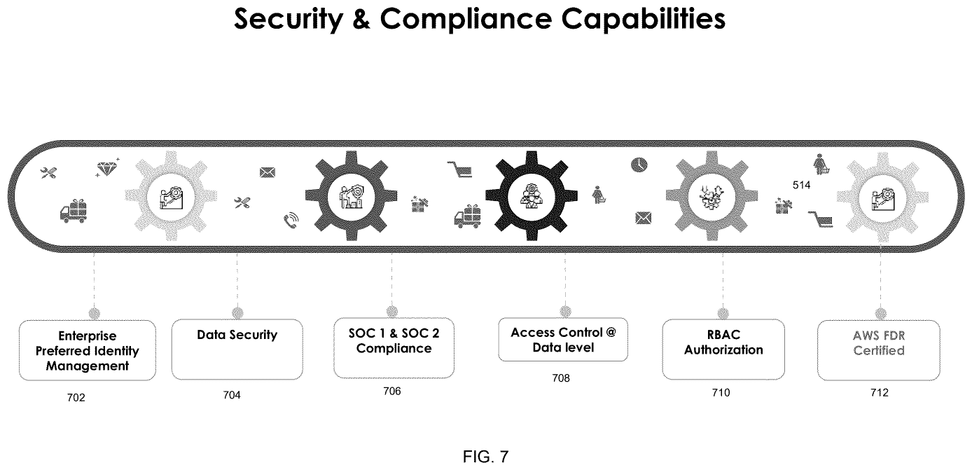

FIG. 7 is a diagram illustrating exemplary security and compliance capabilities of components of an Absolute Zero-Code Application Composition Platform and “Absolute zero code” technology, including for example, enterprise preferred identity management 702, data security 704, SOC 1 and SOC 2 compliance 706, access control at data level 708, RBAC authorization 710, and/or AWS FDR 712, among other things.

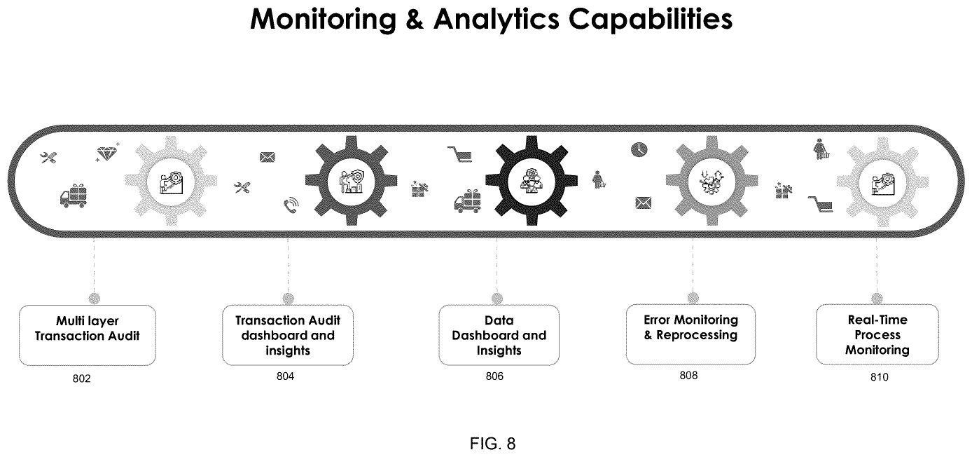

FIG. 8 is a diagram illustrating exemplary monitoring and analytics capabilities of components of an Absolute Zero-Code Application Composition Platform and “Absolute zero code” technology, including for example, multi-layer transaction audit 802, transaction audit dashboard and insights 804, data dashboard and insights 806, error monitoring and reprocessing 808, and/or real-time process monitoring 810, among other things.

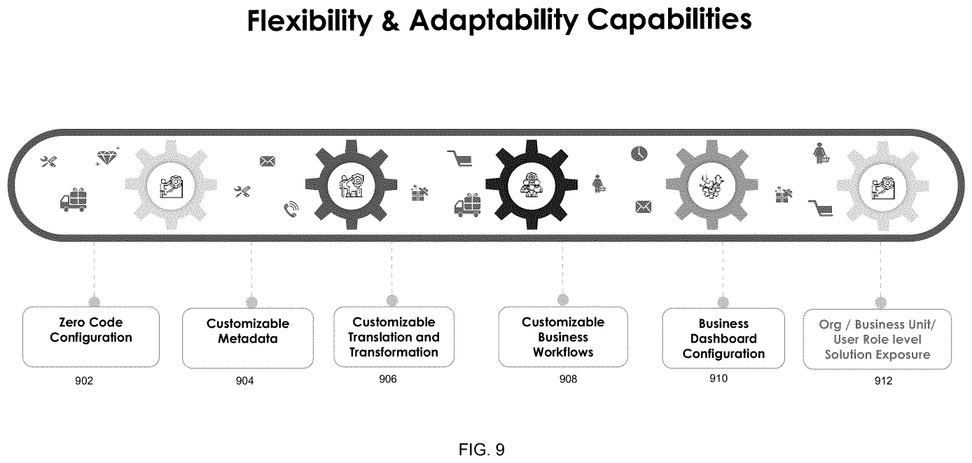

FIG. 9 is a diagram illustrating exemplary flexibility and adaptability capabilities of components of an Absolute Zero-Code Application Composition Platform and “Absolute zero code” technology, including for example, zero code configuration 902, customizable metadata 904, customizable translation and transformation 906, customizable business workflows 908, business dashboard configuration 910, and/or organization/business unit/user role level solution exposure 912, among other things.

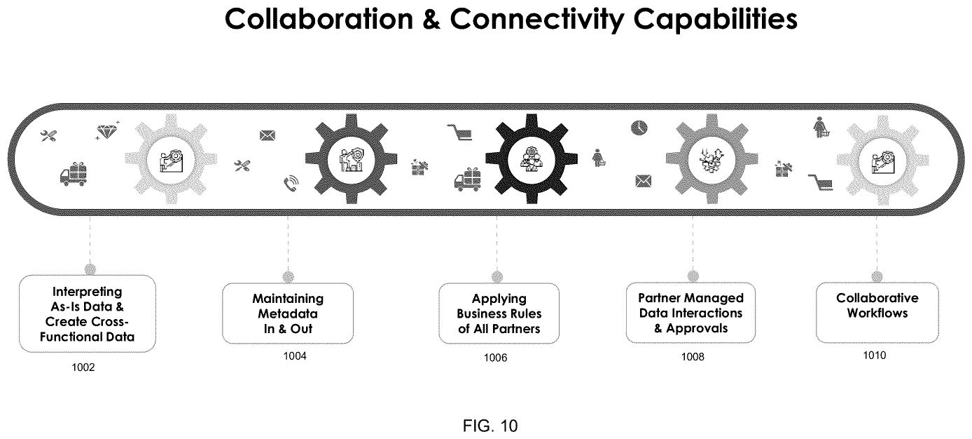

FIG. 10 is a diagram illustrating exemplary collaboration and connectivity capabilities of components of an Absolute Zero-Code Application Composition Platform and “Absolute zero code” technology, including for example, interpreting as-is data and creating cross-functional data 1002, maintaining metadata in and out 1004, applying business rules of all partners 1006, partner managed data interactions and approvals 1008, and/or collaborative workflows 1010, among other things.

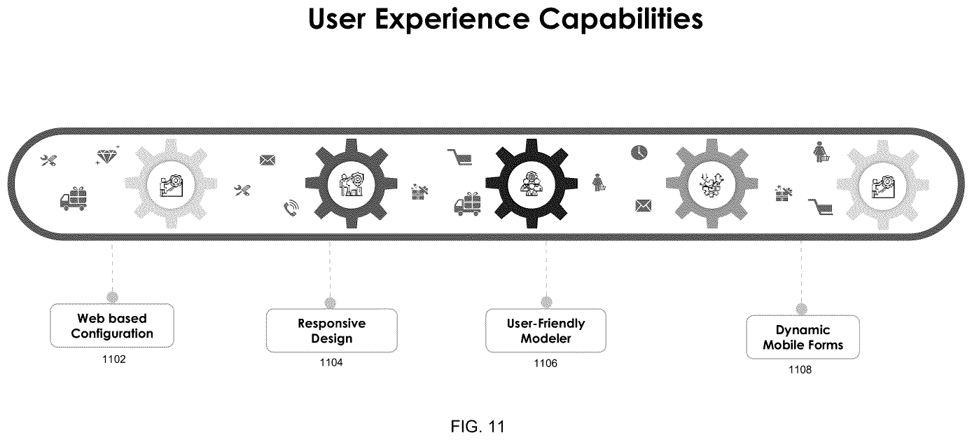

FIG. 11 is a diagram illustrating exemplary user experience capabilities of components of an Absolute Zero-Code Application Composition Platform and “Absolute zero code” technology, including for example, web based configuration 1102, responsive design 1104, user-friendly modeler 1106, and/or dynamic mobile forms 1108, among other things.

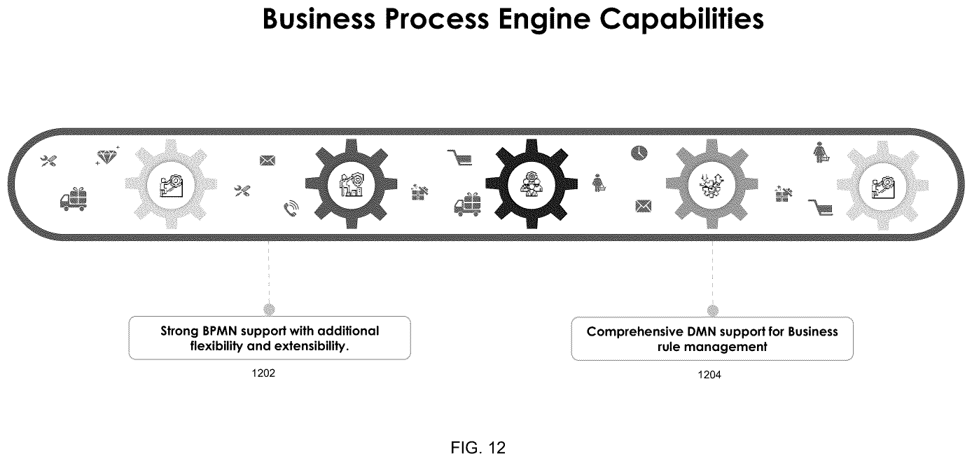

FIG. 12 is a diagram illustrating exemplary business process engine capabilities of components of an Absolute Zero-Code Application Composition Platform and “Absolute zero code” technology, including for example, strong BPMN support with additional flexibility and extensibility 1202 and/or comprehensive DMN support for business rule management 1204, among other things.

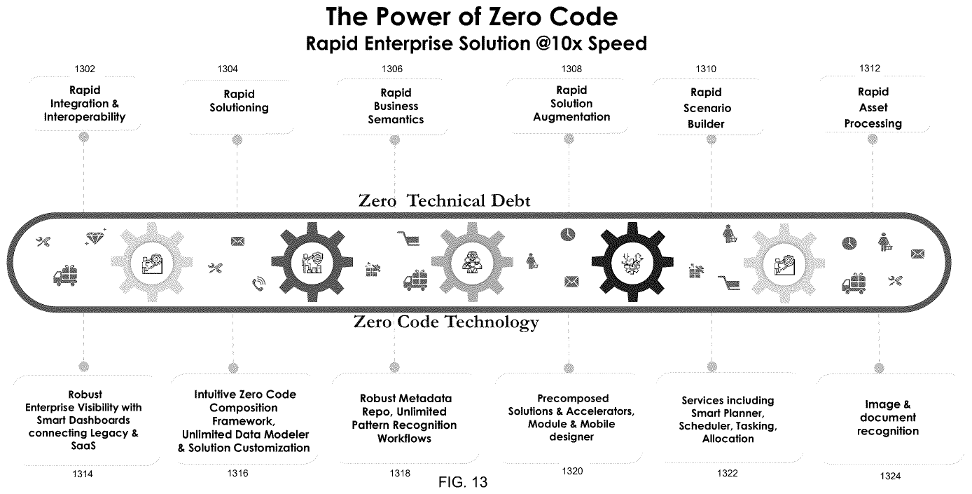

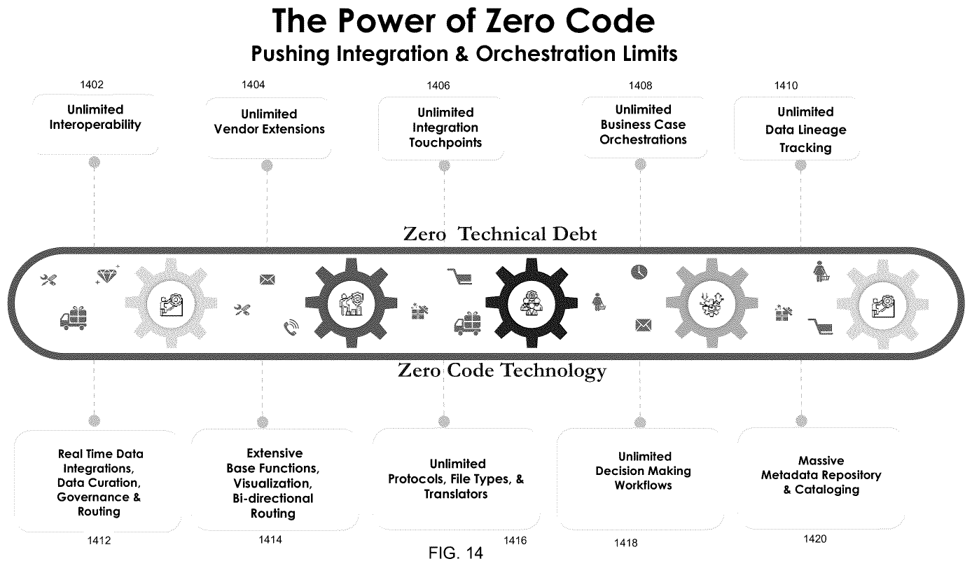

FIGS. 13-14 illustrate exemplary aspects of an Absolute Zero-Code Application Composition Platform and “Absolute zero code” technology providing a rapid enterprise solution (e.g., at 10× speed).

FIG. 13 is a diagram illustrating that the exemplary platform provides rapid enterprise solutions by enabling rapid integration and interoperability 1302, rapid solutioning 1304, rapid business semantics 1306, rapid solution augmentation 1308, rapid scenario builder 1310, rapid asset processing 1312, robust enterprise visibility with smart dashboards connecting legacy and SaaS 1314, intuitive zero code composition framework, unlimited data modeler and solution optimization 1316, robust metadata repo, unlimited pattern recognition workflows 1318, precomposed solutions and accelerators, module and mobile designer 1320, services including smart planner, scheduler, tasking, allocation 1322, and/or image and document recognition 1324, among other things.

FIG. 14 is a diagram illustrating exemplary components and capabilities of an Absolute Zero-Code Application Composition Platform and “Absolute zero code” technology providing a rapid enterprise solution, including for example, unlimited interoperability 1402, unlimited vendor extensions 1404, unlimited integration touchpoints 1406, unlimited business case orchestrations 1408, unlimited data lineage tracking 1410, real time data integrations, data curation, governance and routing 1412, extensive base functions, visualization, bi-directional routing 1414, unlimited protocols, file types, and translators 1416, unlimited decision making workflows 1418, and/or massive metadata repository and cataloging 1420, among other things.

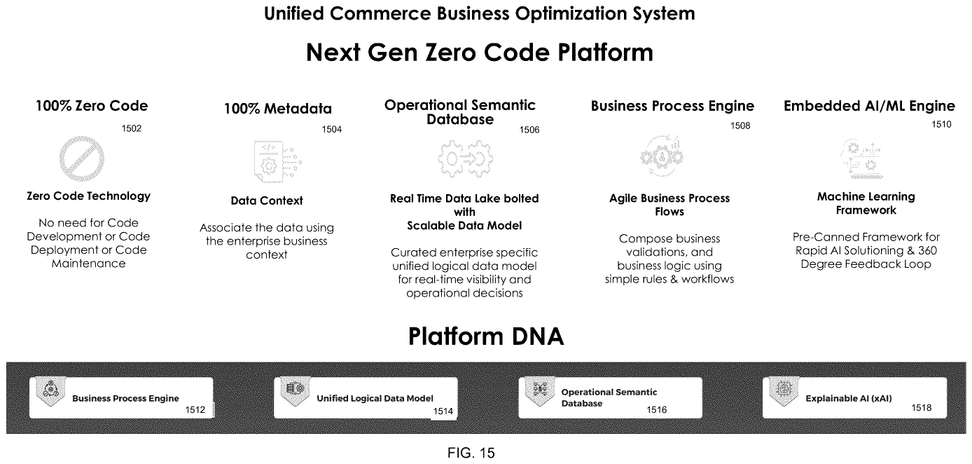

With reference to FIG. 15, an exemplary Absolute Zero-Code Application Composition Platform includes 100% zero code. The platform utilizes zero code technology 1502, and therefore, does not require code, development of code, deployment of code, or code maintenance. The platform utilizes 100% Metadata 1504 and, for example, associates the data using the enterprise business context. The platform utilizes an operational semantic database 1506. In an example, the platform includes a real time data lake bolted with a scalable data model. In an example, the platform includes a curated enterprise specific unified logical data model for real-time visibility and operational decisions. In the illustrated example, the platform utilizes a business process engine 1508. In this example, the platform includes agile business process flows. In this example, the platform composes business validations, and business logic using simple rules and workflows. In this example, the platform includes an embedded AI/ML engine 1510. In this example, the platform includes machine learning framework, which can include, for example, a pre-canned framework for rapid AI solutioning and for providing a 360 degree feedback loop. With reference again to FIG. 15, an exemplary embodiment includes a business process engine 1512, a unified logical data model 1514, an operation semantic database 1516, and an AI/ML engine 1518.

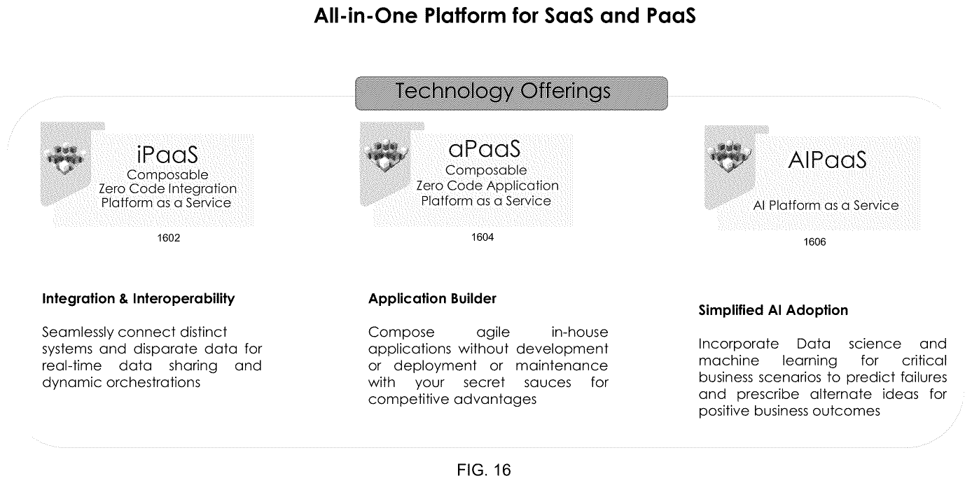

FIG. 16 is a diagram illustrating features and components of an exemplary all-in-one platform for SaaS and PaaS. For iPaaS (Composable Zero Code Integration Platform as a Service) 1602, the exemplary platform provide integration and interoperability, for example, by seamlessly connecting distinct systems and disparate data for real-time data sharing and dynamic orchestrations. For aPaaS (Composable Zero Code Application Platform as a Service) 1604, the exemplary platform can enable application building, for example, by composing agile in-house applications without development or deployment or maintenance while maintaining the company's secrets (e.g., secret sauces) for competitive advantages. For AIPaaS (AI Platform as a Service) 1606, the exemplary platform enable simplified AI adoption, for example, by incorporating data science and machine learning for critical business scenarios to predict failures and prescribe alternate ideas for positive business outcomes.

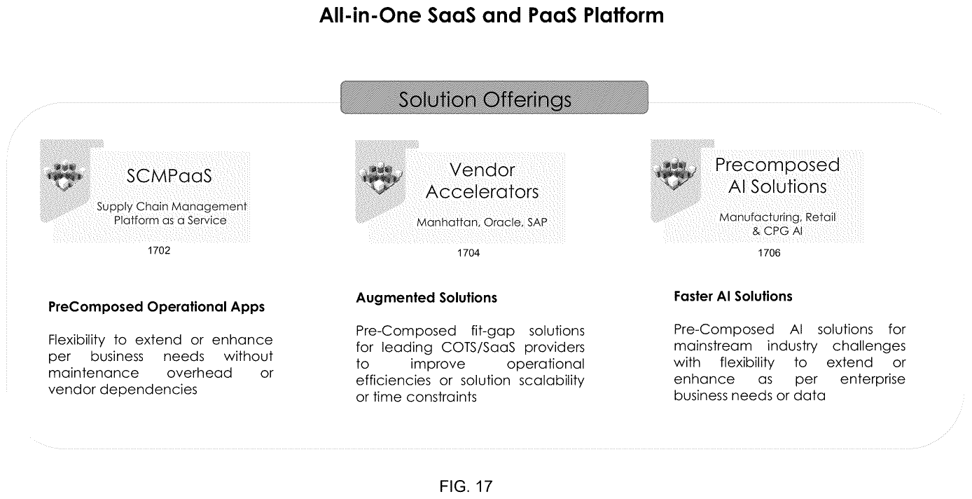

FIG. 17 is another diagram illustrating features and components of an exemplary all-in-one platform for SaaS and PaaS. For SCMPaaS (Supply Chain Management Platform as a Service) 1702, the exemplary platform provides precomposed operational apps, for example, providing flexibility to extend or enhance as per business needs without maintenance overhead or vendor dependencies. For vendor accelerators (e.g., Manhattan, Oracle, SAP, etc.), the exemplary platform provides augmented solutions including, for example, pre-composed fit-gap solutions for leading COTS/SaaS providers to improve operational efficiencies or solution scalability or time constraints. For Precomposed AI Solutions, such as manufacturing, retail, and CPG AI, the exemplary platform provides faster AI solutions including, for example, pre-composed AI solutions for mainstream industry challenges with flexibility to extend or enhance as per enterprise business needs or data.

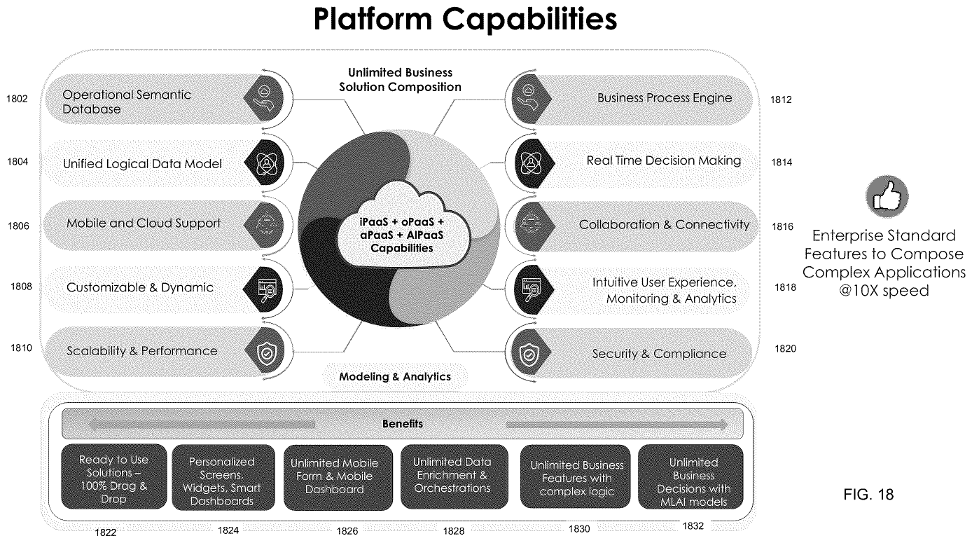

FIG. 18 is a diagram illustrating exemplary components and capabilities of an Absolute Zero-Code Application Composition Platform for iPaaS, oPaaS, aPaaS, and/or AIPaaS. The components and capabilities include, for example:
Operational Semantic Database 1802;
Unified Logical Data Model 1804;
Mobile and Cloud Support 1806;
Customizable and Dynamic 1808;
Scalability and Performance 1810;
Business Process Engine 1812;
Real-Time Data Decisioning 1814;
Collaboration and Connectivity 1816;
Intuitive User Experience, Monitoring and Analytics 1818; and/or
Security and Compliance 1820, among other things.

The exemplary platform includes, for example, ready to use solutions (e.g., 100% drag and drop) 1822, personalized screens, widgets, and smart dashboards 1824, unlimited mobile form and mobile dashboard 1826, unlimited data enrichment and orchestrations 1828, unlimited business features with complex logic 1830, and/or unlimited business decisions with MLAI models 1832, among other things.

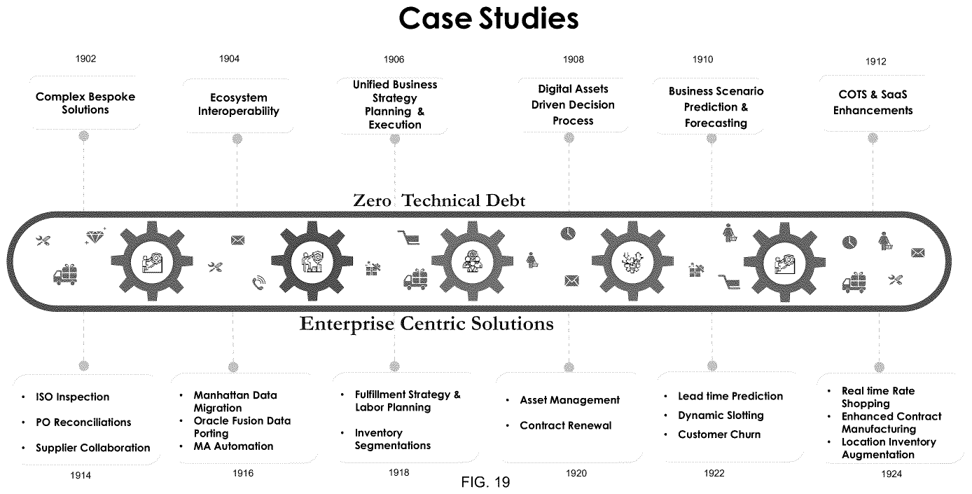

FIG. 19 is a diagram illustrating case studies for enterprise centric solutions provided by an exemplary platform with zero technical debt. The solutions include, for example, complex bespoke solutions 1902, ecosystem interoperability 1904, unified business strategy planning and/or execution 1906, digital assets driven decision process 1908, business scenario prediction and/or forecasting 1910, COTS and SaaS enhancements 1912, ISO Inspection, PO Reconciliations, and/or Supplier Collaboration 1914, Manhattan Data Migration, Oracle Fusion Data Porting, and/or MA Automation 1916, Fulfillment Strategy and Labor Planning and/or Inventory Segmentations 1918, Asset Management and/or Contract Renewal 1920, Lead time Prediction, Dynamic Slotting, and/or Customer Churn 1922, Real time Rate Shopping, Enhanced Contract Manufacturing, and/or Location Inventory Augmentation 1924, among other things.

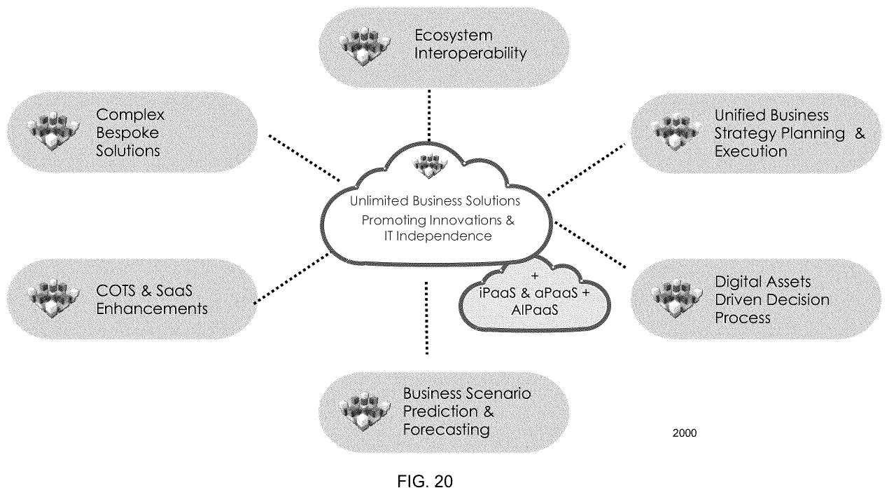

FIG. 20 is a diagram illustrating exemplary components of an Absolute Zero-Code Application Composition Platform 2000.

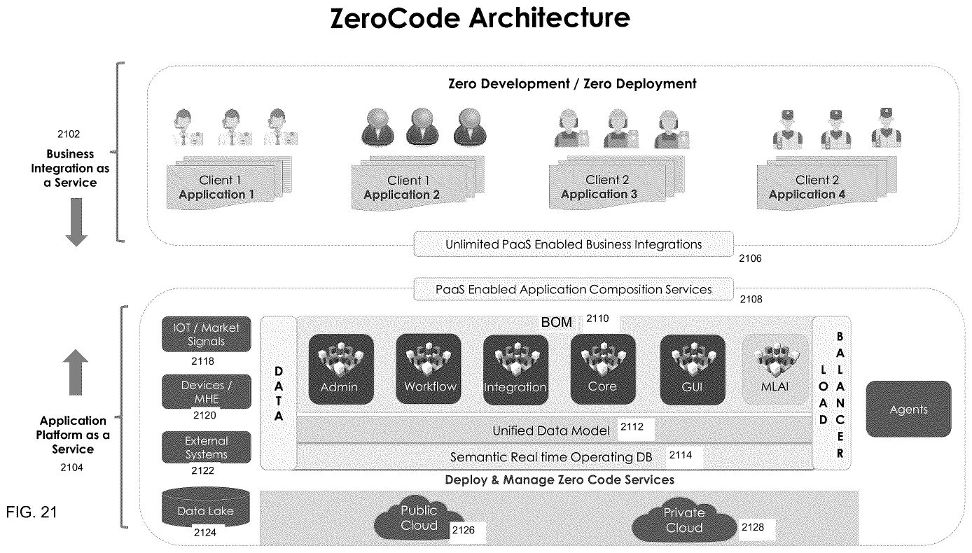

With reference to FIGS. 21-33, exemplary embodiments of an Absolute Zero-Code Application Composition Platform according to the invention will now be described.

### Platform Overview Diagram

FIG. 21 illustrates an overall architecture and core components of an Absolute Zero Code platform according to an embodiment of the invention, illustrating the modular, scalable, and integration-centric design of the platform. The architecture is illustrated through a comprehensive diagram that highlights exemplary components and their relationships.

The architecture enables business integration as a service 2102 and application platform as a service 2104, allowing seamless connectivity between disparate systems, applications, and data sources. FIG. 21 shows connections between clients, applications, and the central platform.

The architecture supports Unlimited PaaS Enabled Business Integrations 2106 and exemplarily illustrates multiple clients (e.g., Client 1, Client 2) and their respective applications (e.g., Application 1, Application 2, Application 3, Application 4), which are interconnected through the platform. The platform provides the ability to support unlimited integrations across various business units, partners, and/or external systems, thereby ensuring and providing seamless business connectivity.

The architecture supports unlimited Platform-as-a-Service (PaaS) enabled application composition services 2108 for composing applications, enabling rapid deployment and management of business solutions without code development. The platform provides the ability to provide application composition as a service, allowing users to build, deploy, and manage business applications without writing code, thereby enabling rapid solutioning and integration. The platform includes Bill of Materials (BOM) 2110 and administrative functions, supporting configuration, management, and governance of business processes and integrations. A unified data model 2112 is provided, serving as the foundation for real-time data integration, semantic modeling, and interoperability across the platform. The architecture includes a semantic real-time operating database 2114, enabling dynamic data ingestion, enrichment, and governance. This supports both structured and unstructured data, facilitating advanced analytics and decision-making. The architecture supports Public Cloud 2126, Private Cloud 2128, and Data Lake components 2124, thereby providing the capability to operate in hybrid environments and leverage cloud-native resources for scalability and resilience. The architecture supports integration with external systems 2124, devices/Material Handling Equipment (MHE) 2120, and IoT/market signals 2118, enabling real-time data exchange and process automation. Data ingestion and balancing mechanisms are depicted, ensuring efficient data flow and load management across the platform.

With reference again to the Application Platform as a Service 2104, the platform provides application composition, deployment, and management as a service, supporting workflow integration, core business logic, graphical user interfaces (GUI), machine learning/artificial intelligence (MLAI), and agent-based automation. The architecture includes admin, workflow, integration, and core elements for orchestrating business processes, a GUI for user interaction and configuration, MLAI for embedded AI/ML capabilities, and agents for automated service management. The platform enables zero development and zero deployment, allowing users to deploy and manage services entirely through configuration, without writing or maintaining code. The overall architecture illustrates zero-code application composition, unlimited integration, and scalable enterprise solutions.

As described with reference to the exemplary embodiments herein, the present invention rethinks software application blueprints by providing truly zero hardcoding and zero assumptions, and provides an “absolute zero code” technology having an empty software shell which has no data models, no tables, no data, no business logic, no integrations and no applications. However, the present invention has the advanced smartness to learn and compose any type of complex ERP like data models, understand any form of structured and unstructured data, compose unlimited business rules and logic, and compose unlimited user interfaces to interoperate between all data lakes, ERPs, packaged applications, legacy systems, spreadsheets, people, machines and things, and thus, creating unlimited ERP like solutions and bespoke innovative solutions for all business functions and all industry verticals without creating a single new line of code.

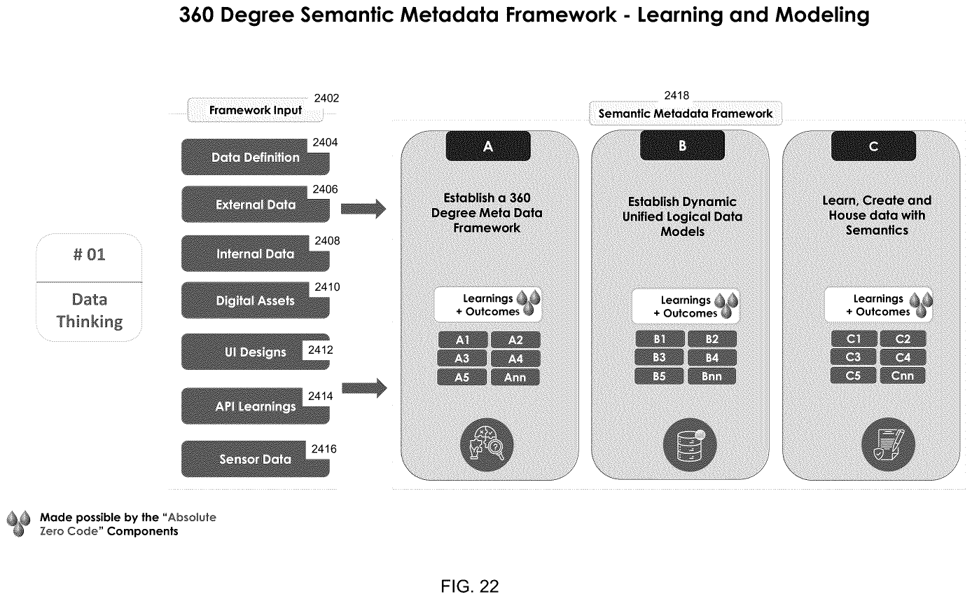

Referring now to the exemplary embodiments illustrated in FIGS. 22-24, the present invention takes a data thinking approach to learn and save substantially all data (e.g., all data) as metadata and semantics. The present invention provides a 360-degree semantic metadata framework having the ability to learn all the external input, internal design, and external output expectations, all as semantic meta data and enable a 360-degree process of creating:
A) a 360-degree metadata framework,
B) Dynamic Unified Logical Data Models, and
C) Data with Semantics embedded.

The exemplary embodiment utilizes:
#1) a data thinking approach and framework,
#2) a design thinking approach and framework, and
#3) a user acceptance thinking approach and framework.

FIG. 22 is a diagram illustrating exemplary aspects of a data thinking approach (#1) having a 360 degree semantic metadata framework (A, B, C), and learning and modeling flow, for an Absolute Zero-Code Application Composition Platform, according to an exemplary embodiment of the invention. FIG. 22 shows the structure and flow of metadata learning and management within the platform, and illustrates the process by which the platform learns and manages metadata, and illustrates the flow from external and internal data sources, through establishing a 360-degree metadata framework, establishing Dynamic Unified Logical Data Models, and learning, creating, and housing data with semantics embedded.

As shown in the example, the platform is capable of handling structured and unstructured data, digital assets, UI designs, and API learnings. For example, with reference to the data thinking model illustrated in FIG. 22, the framework input 2402 includes, for example, one or more of data definitions 2404, external data 2406, internal data 2408, digital assets 2410, UI designs 2412, API learnings 2414, and/or sensor data 2416, among other things. The semantic metadata framework 2418 receives the framework input 2402. At step A, the framework establishes a 360-degree metadata framework. At step B, the framework establishes dynamic unified logical data models. At step C, the framework learns, creates, and houses data with semantics embedded. The learnings and outcomes are made possible by Absolute Zero Code components.

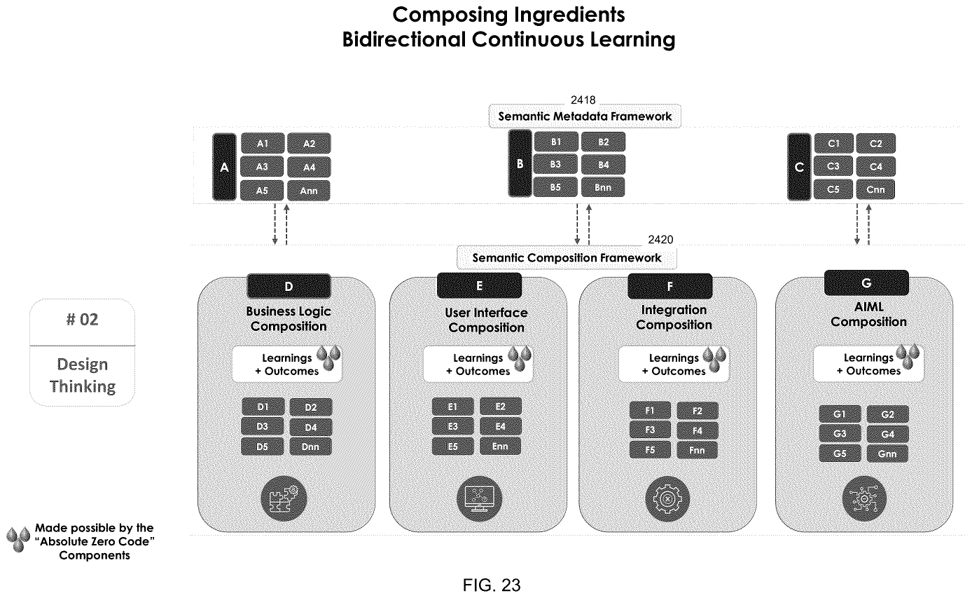

FIG. 23 is a diagram illustrating exemplary aspects of a design thinking approach (#2) having a semantic composition framework 2420 for identifying and composing the ingredients, and enabling bidirectional continuous learning, for an Absolute Zero-Code Application Composition Platform, according to an exemplary embodiment of the invention. Based on the established semantic metadata framework 2418, the semantic composition framework 2420 composes the granular ingredients required for all the journeys by addressing, for example, four main areas including, for example:
D) Business Logic,
E) User Interface,
F) Integration, and
G) Artificial Intelligence and Machine Learning.

As shown in FIG. 23, in the design thinking approach (#2), the semantic composition framework 2420 receives the learnings and outcomes (A1, A2, A3, A4, A5, . . . Ann) from the established 360-degree metadata framework (from Step A), the learnings and outcomes (B1, B2, B3, B4, B5, . . . Bnn) from the established dynamic unified logical data models (from Step B), and the learned, created, and housed data (C1, C2, C3, C4, C5, . . . Cnn) from the learned, created, and housed data with semantics (from Step C). The Business Logic Composition framework (D) composes learnings and outcomes (D1, D2, D3, D4, D5, . . . Dnn). The User Interface Composition framework (E) composes learnings and outcomes (E1, E2, E3, E4, E5, . . . Enn). The Integration Composition framework (F) composes learnings and outcomes (F1, F2, F3, F4, F5, . . . Fnn). The AIML Composition framework (G) composes learnings and outcomes (G1, G2, G3, G4, G5, . . . Gnn).

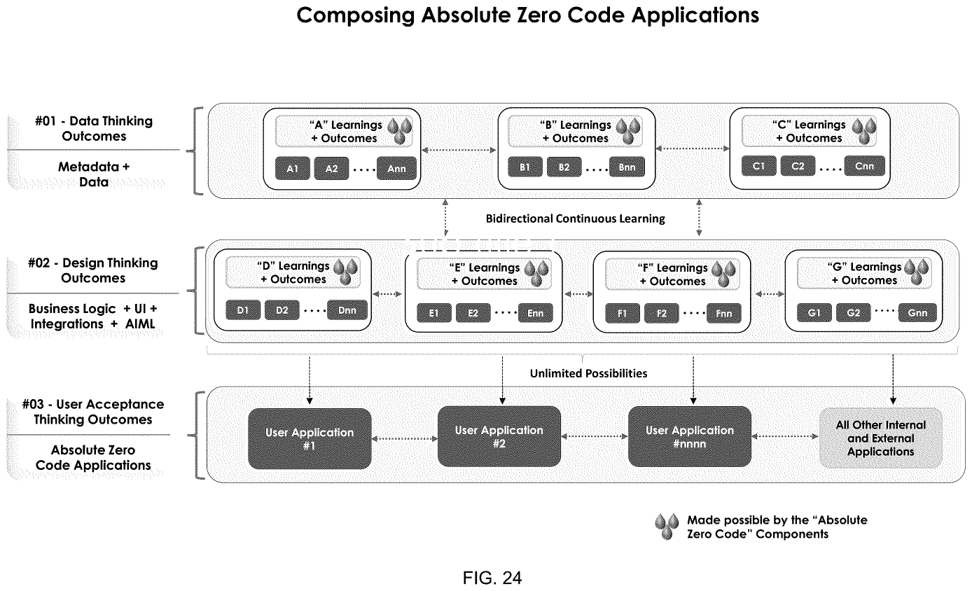

Next, with reference to FIG. 24, a user acceptance thinking approach (#3) is utilized for composing applications. For example, based on the “#1-Data Thinking” learnings and outcomes, and the “#2-Design Thinking” learnings and outcomes, the present invention provides a framework for composing complex business applications from the user acceptance point of view without any code development, code level testing or code deployment across the end-to-end development and deployment life cycles, and also across all the applications and all the internal and external software ecosystems and data lakes.

With reference to FIG. 24, a process and flow for an Absolute Zero-Code Applications Composition Platform for composing absolute zero-code applications according to an exemplary embodiment of the invention will now be described. As shown in FIG. 24, the platform enables and provides bidirectional continuous learning between the (#1) data thinking outcomes and established metadata framework, data models, and data, and the (#2) design thinking outcomes and D) Business Logic, E) User Interface, F) Integration, and G) Artificial Intelligence and Machine Learning.

The (#3) user acceptance thinking outcomes provide unlimited possibilities for composing absolute zero-code applications. The platform provides Absolute Zero Code technology having components which are capable of creating any learnings and outcomes outlined in steps A, B, C, D, E, F, and G across the three thinkings: (1) Data Thinking, (2) Design Thinking, and (3) User Acceptance Thinking.

With reference again to FIGS. 22-24, the system can receive any form of data as input and learn the metadata. The system is not concerned with the context of the data itself, what it is, or what it is for; it is primarily concerned with (e.g., only concerned with) the metadata. In other words, the system only knows or recognizes that it has received one or more attributes or pieces of information about the data. As an example, the system acknowledges that it has received, for example, twenty (20) attributes or pieces of information about the data. The system is not concerned with (i.e., does not care) what the data is or what the data is for, or even what the attributes or pieces of information are, or what they are for; just that there are twenty (20) attributes or twenty (20) pieces of information. The system learns and understands the information or attributes (e.g., blindly learns and understands the information or attributes without regard to what the corresponding data is or what the data is for), for example, the heading field, tag name, etc. If there is no heading, then the system can be configured such that a user is able to define the metadata, for example, via the user interface of the platform.

Next, using the metadata, the system creates data models based on the received data. In the example above, the system then groups the twenty (20) attributes or pieces of information (from Step A) into data models (Step B). For example, the attributes or pieces of information can be grouped, for example, by company name, customers, services, costs, etc., among other things. In an example, the system can be configured such that a user is able to define the data models, for example, via the user interface of the platform. That is, the system can be configured such that a user is able to define the data models, for example, for an HR team, litigation team, real estate legal, among various others, using the user interface. Substantially all (e.g., all) user input and functions can be performed via a user interface, such as using drag and drop features, click button features, etc., among other things. In some examples, the steps can be automated. For example, the platform can utilize a tool (e.g., an automation tool) that receives definitions of the data, or a simple tool that can be filled out (e.g., .xls), and then the system can convert (e.g., automatically convert) to data models.

Next, now that the system knows the metadata (Step A) and has created the data models (Step B), the system learns, creates, and houses data with semantics embedded. That is, using the same metadata, the platform defines metadata level rules (e.g., business rules) to simply put the data into the appropriate/correct data models. For example, the system can be configured to create rules (e.g., English rules) using the metadata and then channel the data into the correct data model. For example, if the Customer Code is U.S., then data can be put in US entries.

In the examples, no coding is needed or performed. Instead, examples of the system are configured with a simple framework using English such that a user can simply type in how to interpret the data and how to channel the data into the data models (e.g., only create unpaid invoices, etc.).

The intelligent empty shell is capable of learning and creating any data model and any data from any application and any data ecosystem without boundaries. For example, the exemplary system can learn a financial data model, compose financial business logic, and allow the composition of business user interfaces/applications without creating a single line of code. In another example, the exemplary system can learn a warehousing data model and allow the composition of warehousing data applications without creating a single line of code.

In an example, the system can be configured to grow or learn, for example, as new data models are created. The system can be configured to communicate between models.

The exemplary embodiments improve over prior systems by allowing an enterprise to define and continuously refine their assumptions, user/system inputs, and expected system outputs. The exemplary embodiments eliminate rigidities (e.g., all the rigidities) and allow business and technical architects to produce unlimited scenarios and solutions as outcomes with zero technical debt. In this way, the exemplary embodiments provide increased speed (e.g., 10 times more speed) to market with zero throw away code and cost. According to the exemplary embodiments of the present invention, applications can be independent (e.g., 100% independent) of the technology and hence the so-called “secret sauces” and customizations required can be accomplished with zero vendor dependencies and zero code. As a result, there is no more innovation ceiling for IT and Business, unlike with prior systems.

Moreover, unlike prior systems, the exemplary embodiments provide end to end solutioning using 100% meta data. In contrast to the prior systems, and as an improvement over those prior systems, the exemplary embodiments of the present invention provide Zero Code Technology, and more particularly, Absolute Zero Code Technology. The exemplary embodiments described herein enable users to design, configure, and deploy enterprise-grade applications without writing, generating, or maintaining any software code by implementing the platform as an intelligent, empty software shell that contains no pre-existing data models, tables, business logic, integrations, or applications, and leveraging a semantic metadata framework and unified logical data model to learn, compose, and orchestrate any type of business process, data integration, user interface, or artificial intelligence (AI) model through configuration alone. Importantly, the platform improves upon prior systems and methods by enabling the composition, deployment, and maintenance of enterprise applications entirely through configuration, without generating, packaging, or maintaining any software code. The platform leverages a semantic metadata framework, unified logical data model, and operational semantic database to support unlimited solutioning, interoperability, and continuous refinement of business applications for any function or industry vertical.

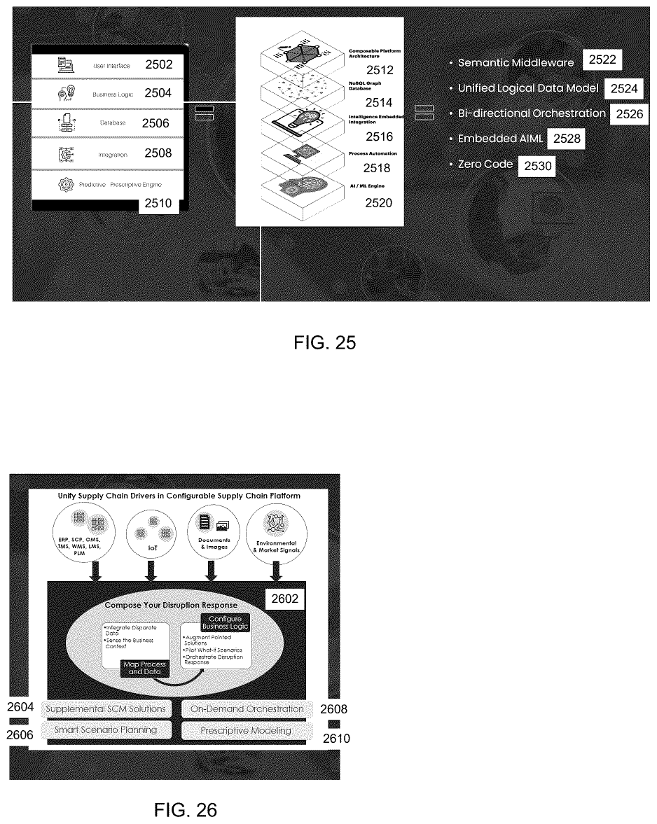

FIG. 25 is a diagram illustrating exemplary architecture of an Absolute Zero-Code Application Composition Platform, according to an exemplary embodiment of the invention. FIG. 25 illustrates exemplary architecture having a user interface 2502, business logic 2504, database 2506, integration 2508, predictive-prescriptive engine 2510, an exemplary architecture having a composable platform architecture 2512, NoSQL Graph database 2514, intelligence embedded integration 2516, process automation 2518, and AIML engine 2520, and an exemplary architecture having semantic middleware 2522, unified logical data model 2524, bi-direction orchestration 2526, embedded AIML 2528, and zero code 2530.

FIG. 26 is a diagram illustrating an example implementation of an Absolute Zero-Code Application Composition Platform, according to an exemplary embodiment of the invention, for unifying supply chain drivers in a configurable supply chain platform. This example shows example platform inputs, such as ERP, SCP, OMS, TMS, WMS, LMS, and/or PLM, IoT, documents and images, environmental and market signals. The examples shows a process 2602 of composing a disruptive response, including a map process and data in disparate data is integrated, and a business context is sensed, and a business logic configuration process including augmenting pointed solutions, piloting what-if scenarios, and orchestrating a disruption response. The example further illustrates capabilities for Supplemental SCM Solutions 2604, Smart Scenario Planning 2606, On-Demand Orchestration 2608, and Prescriptive Modeling 2610. The exemplary embodiments described herein enable a user to digitalize a company's legacy, generate business KPIs across verticals, enhance ERP and SCM, eliminate redundant technologies, reach full interoperability, predict problems sooner, and/or produce outcomes faster.

### Platform Architecture-Components Diagram

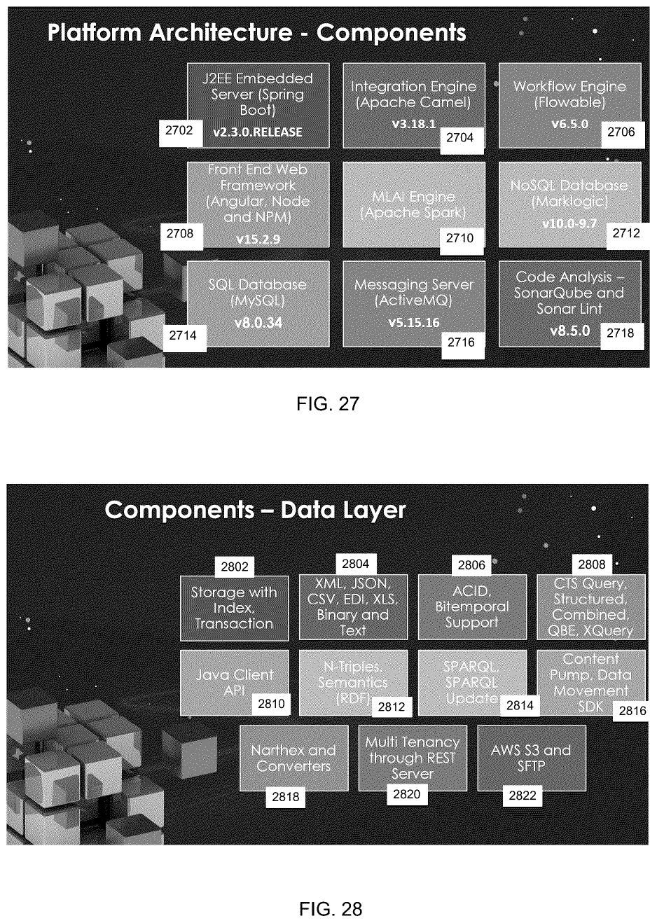

FIG. 27 is a diagram detailing the technical stack of the platform and integration of various engines and databases, including the embedded server 2702, integration engine 2704, workflow engine 2706, front-end web framework 2708, ML/AI Engine 2710, NoSQL database 2712, SQL databases 2714, messaging server 2716, and code analysis tools 2718. The diagram demonstrates how these components are integrated to support the zero-code paradigm and enterprise-grade scalability.

### Components—Data Layer Diagram

FIG. 28 is a diagram detailing the component data layer of the platform, including Storage with Index-Transaction 2802, XML, JSON, CSV, EDI, XLS, Binary and Text Transaction 2804, ACID, Bitemporal Support 2806, CTS Query, Structured, Combined, QBE, XQuery 2808, Java Client API 2810, N-Triples, Semantics (RDF) 2812, SPARQL, SPARQL Update 2814, Content Pump, Data Movement SDK 2816, Narthex and Converters 2818, Multi Tenancy through REST Server 2820, and AWS S3 and SFTP 2822.

### Business Process Engine Diagram

FIG. 29 is a diagram illustrating the configuration and orchestration of business processes within the platform. The diagram demonstrates the configuration and orchestration of business processes, and shows support for BPMN 2.0, process definition XML, event sequencing, task management, and multitenancy. The diagram emphasizes the platform's ability to model, schedule, and audit business processes through configuration alone. In this example, the components of the business process engine include Custom Process Definition Generation 2902, Schedule Process, Resume Process, Sub Process 2904, BPMN 2.0, Process Definition XML, Delegate 2906, Events, Sequences, Gateways, Tasks, Parallel Process 2908, Transactions, Auditing, Re-Processing 2910, Multitenancy through Tenant Id 2912, Task List, Assign Task, Complete Task, Escalate Task 2914, and Schedule Task, Resume Task 2916.

### Integration Engine Diagram

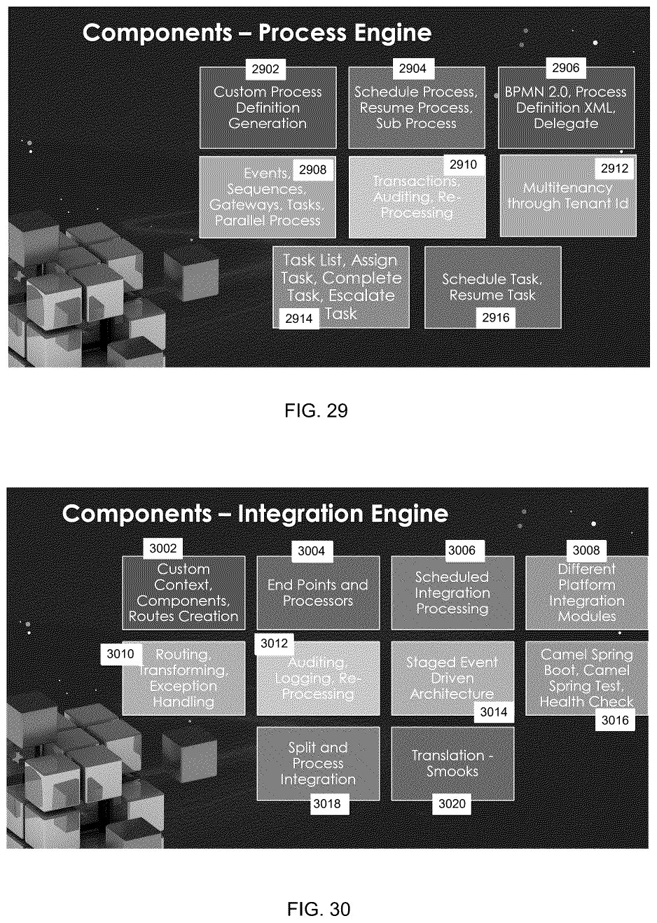

FIG. 30 is a diagram illustrating components of the integration engine providing the platform's integration capabilities, including custom context creation, route management, scheduled integration processing, and support for various protocols and data formats. The diagram illustrates the platform's integration capabilities and ability to connect with external systems, handle routing and transformation, and provide robust auditing and logging features. In this example, the components of the integration engine include Custom Context, Components, Routes Creation 3002, End Points and Processors 3004, Scheduled Integration Processing 3006, Different Platform Integration Modules 3008, Routing, Transforming, Exception Handling 3010, Auditing, Logging, Re-Processing 3012, Staged Event Driven Architecture 3014, Camel Spring Boot, Camel Spring Test, Health Check 3016, Split and Process Integration 3018, and Data Translation-Smooks 3020.

### MLAI Engine Diagram

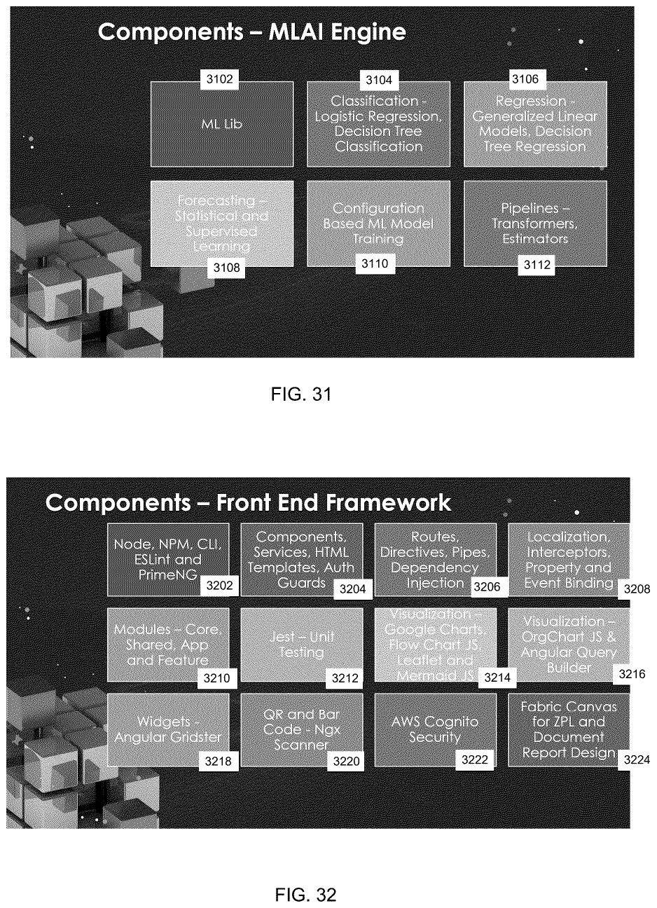

FIG. 31 is a diagram illustrating components of the MLAI engine providing the platform's machine learning/AI capabilities. In this example, the components of the MLAI engine include ML Library 3102, Classification—Logistic Regression, Decision Tree Classification 3104, Regression-Generalized Linear Models, Decision Tree Regression 3106, Forecasting—Statistical and Supervised Learning 3108, Configuration Based ML Model Training 3110, and Pipelines - Transformers, Estimators 3112.

### Front End Framework Diagram

FIG. 32 is a diagram illustrating the user interface components and configuration tools, including web-based configuration tools, responsive design elements, and dynamic mobile forms. It illustrates how users interact with the platform to model data, configure business logic, and deploy applications without writing code. In this example, the components of the front end framework include Node, NPM, CLI, ESLint and PrimeNG 3202, Components, Services, HTML Templates, Auth Guards 3204, Routes, Directives, Pipes, Dependency Injection 3206, Localization, Interceptors, Property and Event Binding 3208, Modules—Core, Shared, App and Feature 3210, Jest—Unit Testing 3212, Visualization—Google Charts, Flow Chart JS, Leaflet and Mermaid JS 3214, Visualization—OrgChart JS and Angular Query Builder 3216, Widgets—Angular Gridster 3218, QR and Bar Code—Ngx Scanner 3220, AWS Cognito Security 3222, and Fabric Canvas for ZPL and Document Report Design 3224.

### Components Spring Framework Diagram

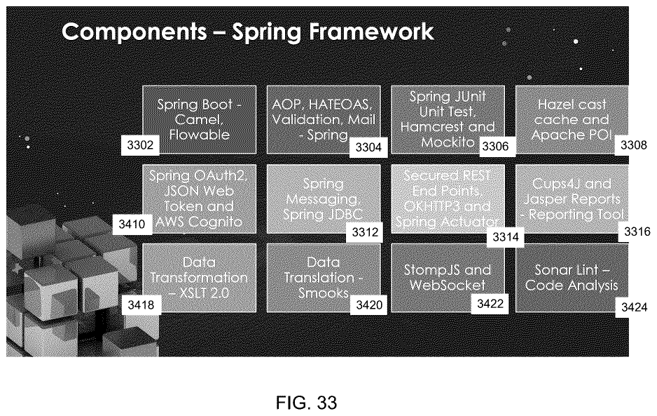

FIG. 33 is a diagram illustrating spring framework components. In this example, the components include Spring Boot—Camel, Flowable 3302, AOP, HATEOAS, Validation, Mail—Spring 3304, Spring JUnit Unit Test, Hamcrest and Mockito 3306, Hazel cast cache and Apache POI 3308, Spring OAuth2, JSON Web Token and AWS Cognito 3310, Spring Messaging, Spring JDBC 3312, Secured REST End Points, OKHTTP3 and Spring Actuator 3314, Cups4J and Jasper Reports—Reporting Tali 3316, Data Transformation—XS LT 2.0 3318, Data Translation—Smooks 3320, StompJS and WebSocket 3322, and Sonar Lint—Code Analysis 3324.

The exemplary embodiments described herein are provided to enable any person skilled in the art to make and use the present invention and sets forth the best mode contemplated by the inventor for carrying out the invention. Various modifications, equivalents, and alternatives will be apparent to those skilled in the art. The description herein is not intended to limit the scope of the invention as defined by the appended claims.

Unless otherwise indicated, the term “application platform” refers broadly to one or more computing systems configured to execute application logic, manage data storage and retrieval, and facilitate communication between client and server components through one or more networks.

In an exemplary embodiment, an application platform comprises one or more computing devices that may include a combination of servers, user devices, and intermediary nodes interconnected via a communication network such as the Internet, an intranet, or a cloud-based infrastructure. The platform may include one or more application servers, database servers, and client interfaces executing under a distributed or microservice architecture.

Each computing device may include at least one processor, such as a central processing unit (CPU), graphics processing unit (GPU), or digital signal processor (DSP), operatively coupled to a memory subsystem. The memory may include volatile memory (e.g., RAM) and non-volatile memory (e.g., flash storage, SSD, or magnetic disk). The platform may further include a network interface, input/output controller, and operating system executing thereon.

The application platform may execute one or more software layers, such as an Operating System Layer—providing kernel services, process management, and hardware abstraction; Middleware Layer—implementing communication protocols, API management, and message-queuing mechanisms; Application Layer—containing program modules that perform specific business logic, workflow orchestration, and user interface rendering; and Data Layer—maintaining structured and unstructured data repositories, including relational databases, object stores, and distributed ledgers.

The system may further support a containerized environment allowing scalable deployment of services across multiple hosts, virtual machines, or cloud instances.

The platform may utilize secure communication protocols to transmit data between components. In some embodiments, the platform may employ an application programming interface (API) to expose services to client applications. The API may conform to REST, GraphQL, gRPC, or other service frameworks. Message passing between services may employ standard formats such as JSON, XML, or protocol buffers.

A data persistence layer may be implemented to manage read/write operations. Databases may include SQL databases. Data consistency may be maintained through transaction management and caching systems. In certain embodiments, metadata about user activity, session states, and application logs is stored for analytics or monitoring.

The platform may include a graphical user interface (GUI) or a web-based dashboard that allows users to access features through browsers or native applications. Developers may access administrative functions through a command-line interface (CLI), integrated development environment (IDE), or web portal for managing deployments, configurations, and access credentials.

The example application platforms may support composition platforms environments that allow modular integration of independent application components. These may include plug-in systems, micro-frontends, or service-composition layers that dynamically assemble user experiences or workflows. Integration may occur via standard interfaces or middleware buses, allowing interoperability between third-party services or legacy systems.

In some exemplary embodiments, the example platform is hosted within a cloud computing environment that provides elasticity, redundancy, and scalability. Cloud deployment models may include Infrastructure-as-a-Service (IaaS), Platform-as-a-Service (PaaS), or Software-as-a-Service (SaaS). Virtual machines or containers may be orchestrated by control systems that allocate compute and storage resources based on workload demand.

The platform may implement authentication and authorization using security protocols. Encryption may be applied to data in transit and at rest using cryptographic standards. Audit logs may record user actions and system events to maintain compliance with security and privacy standards.

An exemplary computing device suitable for implementing aspects of the invention includes a processor coupled to a system bus, memory, input/output interfaces, network adapter, and storage subsystem. The storage subsystem may contain executable instructions that, when executed by the processor, perform operations of the described methods or processes. In distributed embodiments, multiple computing devices may cooperate over a communication network to execute portions of the application platform.

Program modules described herein may be implemented in hardware, software, or combinations thereof. Software modules may be written in any suitable language and executed on general-purpose or special-purpose processors. The order of operations is not necessarily limiting; steps may be rearranged or executed concurrently depending on the system configuration.

The present invention has been described herein in terms of several preferred embodiments. However, modifications and additions to these exemplary embodiments will become apparent to those of ordinary skill in the art upon a reading of the foregoing description and attachments. It is intended that all such modifications and additions comprise a part of the present invention to the extent that they fall within the scope of the invention.

What is claimed is:

1. A system for zero-code application composition, comprising:
a semantic metadata framework configured to receive framework input comprising at least one of data definitions, external data, internal data, digital assets, user interface designs, API learnings, or sensor data, or a combination of two or more thereof;
a processor configured to establish a 360-degree metadata framework based on the framework input;
a processor configured to establish dynamic unified logical data models from the 360-degree metadata framework;
a processor configured to learn, create, and house data with semantics embedded; and
a semantic composition framework configured to receive learnings and outcomes from the semantic metadata framework, the dynamic unified logical data models, and the semantic data, and to compose application ingredients including at least one of business logic, user interface, integration, or artificial intelligence/machine learning components, or a combination of two or more thereof.

2. The system of claim 1, wherein the system enables bidirectional continuous learning and composition of zero-code applications for deployment across internal and external applications.

3. The system of claim 1, wherein the semantic metadata framework is further configured to handle both structured and unstructured data.

4. The system of claim 1, wherein the semantic composition framework is configured to compose business logic by aggregating learnings and outcomes from the metadata framework and unified logical data models.

5. The system of claim 1, wherein the semantic composition framework is configured to compose user interface elements based on learnings and outcomes from the metadata framework and unified logical data models.

6. The system of claim 1, wherein the semantic composition framework is configured to compose integration components for connecting with external systems and APIs.

7. The system of claim 1, wherein the semantic composition framework is configured to compose artificial intelligence and machine learning components for predictive and prescriptive analytics.

8. The system of claim 1, wherein the system supports application composition and deployment without generating, packaging, or maintaining software code.

9. The system of claim 1, wherein the system enables real-time interoperability and continuous refinement of business logic, user interface, integration, and AI/ML components.

10. A method for zero-code application composition, comprising:
receiving, by a semantic metadata framework, framework input comprising at least one of data definitions, external data, internal data, digital assets, user interface designs, API learnings, and sensor data;
establishing, by a processor, a 360-degree metadata framework based on the framework input;
establishing, by a processor, dynamic unified logical data models from the metadata framework;
learning, creating, and housing, by a processor, data with semantics embedded; and
composing, by a semantic composition framework, application ingredients including business logic, user interface, integration, and artificial intelligence/machine learning components, based on learnings and outcomes from the metadata framework, the unified logical data models, and the semantic data.

11. The method of claim 10, further comprising enabling bidirectional continuous learning and composition of zero-code applications for deployment across internal and external applications.

12. The method of claim 10, further comprising handling both structured and unstructured data in the semantic metadata framework.

13. The method of claim 10, further comprising composing business logic by aggregating learnings and outcomes from the semantic metadata framework and unified logical data models.

14. The method of claim 10, further comprising composing user interface elements based on learnings and outcomes from the semantic metadata framework and the unified logical data models.

15. The method of claim 10, further comprising composing integration components for connecting with external systems and APIs.

16. The method of claim 10, further comprising composing artificial intelligence and machine learning components for predictive and prescriptive analytics.

17. The method of claim 10, further comprising supporting unlimited application composition and deployment without generating, packaging, or maintaining software code.

18. The method of claim 10, further comprising enabling real-time interoperability and continuous refinement of at least one of business logic, user interface, integration, or AI/ML components, or a combination of two or more thereof.

19. A system for composing enterprise applications, comprising:
an intelligent software shell having no pre-existing data models, tables, business logic, integrations, or applications;
a semantic metadata framework configured to define and manage application elements as metadata;
a unified logical data model for real-time data integration and operational decision-making;
an operational semantic database for ingesting, enriching, and governing structured and unstructured data;
a business process engine for configuring at least one of business process flows, validations, or logic, or a combination of two or more thereof;
integration and orchestration services for connecting to external systems without generating code or maintaining code, or a combination thereof; and
a user experience layer for configuring applications via at least one of web-based tools or mobile forms, or a combination thereof.

20. The system of claim 19, further comprising one or more security and compliance engines for identity management and access control;
wherein the system enables the composition, deployment, and maintenance of applications entirely through configuration, without generating, packaging, or maintaining any software code.

21. The system of claim 19, wherein the semantic metadata framework enables continuous refinement of application elements without code generation.

22. The system of claim 19, wherein the unified logical data model supports interoperability across disparate enterprise systems.

23. The system of claim 19, wherein the business process engine supports configuration of business logic and workflows using graphical tools.

24. The system of claim 19, wherein the integration and orchestration services provide vendor-independent connectivity and process automation.

25. A method for composing enterprise applications, comprising:
providing an intelligent software shell as described in claim 19;
receiving, by the semantic metadata framework, the application elements and defining the application elements as metadata;
creating the unified logical data model based on the metadata;
learning, creating, and housing the data with semantics embedded; and
deploying and maintaining applications without generating or maintaining software code.

26. The method of claim 25, further comprising configuring one or more data models, business logic, user interfaces, and integrations via graphical tools.
